(19) United States
(12) Patent Application Publication
(10) Pub. No.: US 2020/0142249 A1
(43) Pub. Date: May 7, 2020

(54) LIQUID CRYSTAL DISPLAY PANEL AND LIQUID CRYSTAL DISPLAY DEVICE

(71) Applicant: SHARP KABUSHIKI KAISHA, Sakai City, Osaka (JP)

(72) Inventors: YUICHI KAWAHIRA, Sakai City, Osaka (JP); KIYOSHI MINOURA, Sakai City, Osaka (JP); AKIRA SAKAI, Sakai City, Osaka (JP); TAKAKO KOIDE, Sakai City, Osaka (JP); MASAHIRO HASEGAWA, Sakai City, Osaka (JP); KOJI MURATA, Sakai City, Osaka (JP)

(21) Appl. No.: 16/618,102

(22) PCT Filed: May 24, 2018
(86) PCT No.: PCT/JP2018/019917

§ 371 Date: Nov. 27, 2019

(30) Foreign Application Priority Data
May 31, 2017 (JP) 2017-108453

(51) Int. Cl. G02F 1/1335; G02F 1/1343

(52) U.S. Cl. CPC G02F 1/133514; G02F 2001/133388; G02F 1/1343; G02F 1/133512

(57) ABSTRACT

A liquid crystal display panel includes a first polarizing plate; a first λ/4 layer; a first substrate; a second λ/4 layer; a liquid crystal layer; a second substrate; and a second polarizing plate. In an active region, the first substrate includes a plurality of color filter layers including an edge color filter layer located at an end portion of the active region. In an inactive region, the first substrate includes a black matrix and a dummy color filter layer which overlaps the black matrix and is adjacent to the edge color filter layer. A level difference between a surface of the edge color filter layer and a surface of the dummy color filter layer is 1.2 μm or less. The second λ/4 layer overlaps a boundary between the edge color filter layer and the dummy color filter layer.

### TECHNICAL FIELD

The present invention relates to a liquid crystal display panel and a liquid crystal display device. More specifically, the present invention relates to a liquid crystal display panel in a horizontal electric field mode and a liquid crystal display device including the liquid crystal display panel.

### BACKGROUND ART

Liquid crystal display panels are utilized in applications such as televisions, smartphones, tablets, PCs, and car navigation systems. In these applications, liquid crystal display panels are required to have various performances. For example, a liquid crystal display panel for uniforming the display quality in an active region in which an image is displayed has been proposed (see, for example, Patent Literature 1).

### CITATION LIST

### Patent Literature

Patent Literature 1: JP 2013-29778 A

### SUMMARY OF INVENTION

### Technical Problem

However, the conventional liquid crystal display panel exhibits low visibility in a bright place such as the outdoors. The present inventors have extensively investigated the causes of this and found that the luminance in the black display state is increased by the external light reflection (surface reflection and internal reflection) of the liquid crystal display panel, and as a result, the contrast decreases.

On the other hand, the present inventors have paid attention to a configuration in which a circularly polarizing plate (laminated body of linearly polarizing plate and λ/4 layer) is disposed on the opposite side (observation surface side) to the liquid crystal layer with respect to the substrate on the observation surface side among a pair of substrates sandwiching the liquid crystal layer in order to increase visibility in bright places such as the outdoors (to suppress external light reflection). However, it has been difficult to apply a circularly polarizing plate in the case of adopting a liquid crystal display panel in a horizontal electric field mode such as FFS (Fringe Field Switching) mode or IPS (In-Plane Switching) mode as a liquid crystal display panel in order to improve viewing angle characteristics. This is because the liquid crystal display panel is always in the white (bright) display state both when a voltage is not applied and when a voltage is applied but the black (dark) display state cannot be realized in a case in which a circularly polarizing plate is disposed on the observation surface side and the rear surface side of the liquid crystal display panel in a horizontal electric field mode.

On the other hand, the present inventors have found out a configuration in which a circularly polarizing plate is disposed on the opposite side (observation surface side) to the liquid crystal layer with respect to the substrate on the observation surface side among a pair of substrates sandwiching the liquid crystal layer and the λ/4 layer (hereinafter also referred to as “in-cell retardation layer”) is disposed on the liquid crystal layer side (rear surface side). According to such a configuration, it has been found that a configuration is realized which is optically equivalent to a conventional liquid crystal display panel in a horizontal electric field mode with respect to incident light. However, in such a configuration, light leakage may occur at the end portion of the active region in the black display state when a color filter substrate is used as the substrate on the observation surface side.

The present inventors have extensively investigated the causes of this and found the following. In a normal color filter substrate, a black matrix is disposed in an inactive region surrounding the active region while a black matrix and a color filter layer are laminated in the active region. For this reason, the surface of the color filter layer in the active region is located at a position higher than the surface of the black matrix in the inactive region and a level difference is generated between the two regions. In such a state, when the material for the overcoat layer is applied to the active region and the inactive region, the level difference between the two regions are not completely flattened and the overcoat layer at the end portion of the active region (peripheral portion of the active region) is thinner than that at the central portion of the active region. Thereafter, when the material for the in-cell retardation layer is applied onto the surface of the overcoat layer, the in-cell retardation layer is formed at the end portion of the active region to be thicker than that at the central portion of the active region by the thin thickness of the overcoat layer by the flattening effect of the material for the in-cell retardation layer. As a result, even when the retardation of the in-cell retardation layer is set to the optimum value at the central portion of the active region (the region in which the thickness of the in-cell retardation layer is constant), the retardation thereof greatly deviates from the optimum value at the end portion of the active region by the thick thickness. Hence, the retardation imparted in the in-cell retardation layer is greatly different at the central portion and end portion of the active region, thus light leakage occurs at the end portion of the active region in the black display state when being observed through the circularly polarizing plate described above.

Meanwhile, in a configuration which does not have an in-cell retardation layer (a normal liquid crystal display panel in a horizontal electric field mode), the liquid crystal layer is thickened accordingly when the overcoat layer is thin at the end portion of the active region. However, in the black display state, the liquid crystal layer behaves as an isotropic medium with respect to light incident from the rear surface side (for example, linearly polarized light) thus light leakage does not occur even when the thickness of the liquid crystal layer partially changes. Hence, the light leakage at the end portion of the active region described above is a phenomenon peculiar to the configuration having an in-cell retardation layer.

As described above, the liquid crystal display panel in a horizontal electric field mode has a problem of suppressing light leakage at the end portion of the active region while increasing the visibility in a bright place. However, means for solving the above problem has not been found out. For example, the invention described in Patent Literature 1 is not intended for a configuration having an in-cell retardation layer and has room for improvement.

The present invention has been made in view of the above situation, and an object thereof is to provide a liquid crystal display panel in a horizontal electric field mode which exhibits excellent visibility in a bright place and causes suppressed light leakage at the end portion of the active region and a liquid crystal display device including the liquid crystal display panel.

### Solution to Problem

The present inventors have extensively investigated liquid crystal display panels in a horizontal electric field mode which exhibit excellent visibility in a bright place and causes suppressed light leakage at the end portion of the active region and focused on a configuration in which the thickness of the in-cell retardation layer is less likely to change in the active region. Moreover, it has been found out that in the first substrate on the observation surface side among a pair of substrates sandwiching the liquid crystal layer, a dummy color filter layer adjacent to an edge color filter layer located at the end portion of the active region is disposed in the inactive region and the level difference between the surface of the edge color filter layer and the surface of the dummy color filter layer is in a predetermined range. The present inventors have conceived that the above problem can be thus brilliantly solved and achieved the present invention.

In other words, an aspect of the present invention may be a liquid crystal display panel including: in order from an observation surface side to a rear surface side, a first polarizing plate; a first λ/4 layer; a first substrate; a second λ/4 layer; a liquid crystal layer; a second substrate; and a second polarizing plate, the first λ/4 layer having an in-plane slow axis which forms an angle of 45° with a transmission axis of the first polarizing plate and is orthogonal to an in-plane slow axis of the second λ/4 layer, the second substrate including a pair of electrodes which generate a horizontal electric field in the liquid crystal layer when a voltage is applied, the liquid crystal layer including liquid crystal molecules which are homogeneously aligned in a state in which a voltage is not applied between the pair of electrodes, the first substrate including a plurality of color filter layers in an active region in which an image is displayed, the plurality of color filter layers including an edge color filter layer located at an end portion of the active region, the first substrate including a black matrix and a dummy color filter layer which overlaps the black matrix and is adjacent to the edge color filter layer in order from the observation surface side to the rear surface side in an inactive region surrounding the active region, a level difference between a surface of the edge color filter layer and a surface of the dummy color filter layer being 1.2 μm or less, and the second λ/4 layer overlapping a boundary between the edge color filter layer and the dummy color filter layer.

The level difference may be 0.8 μm or less.

A width of the dummy color filter layer may be 75 μm or more.

A color of the dummy color filter layer may be the same as a color of a color filter layer having a thinnest thickness among the plurality of color filter layers.

A color of the edge color filter layer may be blue.

The first substrate may further include an overcoat layer which directly covers the plurality of color filter layers and the dummy color filter layer.

The second λ/4 layer may directly cover the plurality of color filter layers and the dummy color filter layer.

A transmission axis of the first polarizing plate and a transmission axis of the second polarizing plate may be orthogonal to each other.

An alignment direction of the liquid crystal molecules in the liquid crystal layer and a transmission axis of either one of the first polarizing plate or the second polarizing plate may be parallel to each other in a state in which a voltage is not applied between the pair of electrodes.

Another aspect of the present invention may be a liquid crystal display device including the liquid crystal display panel.

### Advantageous Effects of Invention

According to the present invention, it is possible to provide a liquid crystal display panel in a horizontal electric field mode which exhibits excellent visibility in a bright place and causes suppressed light leakage at the end portion of the active region and a liquid crystal display device including the liquid crystal display panel.

### BRIEF DESCRIPTION OF DRAWINGS

FIG. 1 is a schematic cross-sectional view illustrating a liquid crystal display device and a liquid crystal display panel of Embodiment 1.

FIG. 2 is a schematic plan view illustrating a state in which a first substrate and a second λ/4 layer of a liquid crystal display panel of Embodiment 1 are viewed from a liquid crystal layer side (rear surface side).

FIG. 3 is a schematic cross-sectional view illustrating a portion corresponding to a line segment A-A′ in FIG. 2.

FIG. 4 is a schematic cross-sectional view illustrating a portion corresponding to a line segment B-B′ in FIG. 2.

FIG. 5 is a schematic plan view illustrating a state in which a first substrate and a second λ/4 layer of a liquid crystal display panel of Embodiment 2 are viewed from a liquid crystal layer side (rear surface side).

FIG. 6 is a schematic cross-sectional view illustrating a portion corresponding to a line segment C-C′ in FIG. 5.

FIG. 7 is a schematic cross-sectional view illustrating a portion corresponding to a line segment D-D′ in FIG. 5.

FIG. 8 is a schematic plan view illustrating a state in which a first substrate and a second λ/4 layer of a liquid crystal display panel of Embodiment 3 are viewed from a liquid crystal layer side (rear surface side).

FIG. 9 is a schematic cross-sectional view illustrating a portion corresponding to a line segment E-E′ in FIG. 8.

FIG. 10 is a schematic plan view illustrating a state in which a first substrate and a second λ/4 layer of a liquid crystal display panel of Embodiment 4 are viewed from a liquid crystal layer side (rear surface side).

FIG. 11 is a schematic cross-sectional view illustrating a portion corresponding to a line segment F-F′ in FIG. 10.

FIG. 12 is a schematic cross-sectional view illustrating a portion corresponding to a line segment G-G′ in FIG. 10.

FIG. 13 is a schematic plan view illustrating a state in which a first substrate and a second λ/4 layer of a liquid crystal display panel of Embodiment 5 are viewed from a liquid crystal layer side (rear surface side).

FIG. 14 is a schematic cross-sectional view illustrating a portion corresponding to a line segment H-H′ in FIG. 13.

FIG. 15 is a schematic cross-sectional view illustrating a portion corresponding to a line segment J-J′ in FIG. 13.

FIG. 16 is a schematic plan view illustrating a state in which a first substrate and a second λ/4 layer of a liquid crystal display panel of Comparative Example 1 are viewed from a liquid crystal layer side (rear surface side).

FIG. 17 is a schematic cross-sectional view illustrating a portion corresponding to a line segment a-a′ in FIG. 16.

FIG. 18 is a schematic cross-sectional view illustrating a portion corresponding to a line segment b-b′ in FIG. 16.

### DESCRIPTION OF EMBODIMENTS

Hereinafter, the present invention will be described in more detail through embodiments with reference to the drawings. However, the present invention is not limited only to these embodiments. In addition, the configurations of the respective embodiments may be appropriately combined or changed within a range not departing from the gist of the present invention.

In the present specification, “X to Y” means “X or more and Y or less”.

In the present specification, “polarizing plate” which does not accompany “linear” refers to a linear polarizing plate and is distinguished from a circularly polarizing plate.

In the present specification, the λ/4 layer means a retardation layer which imparts an in-plane retardation of a quarter wavelength (λ/4) to light having a wavelength λ and may be a retardation layer which imparts an in-plane retardation of 100 to 176 nm. The in-plane retardation (R) is defined by R=(ns−nf)×d. Here, when the main refractive index in the in-plane direction of the retardation layer is defined as nx and ny, ns denotes the larger one between nx and ny and nf denotes the smaller one between nx and ny. The in-plane slow axis indicates the axis in the direction corresponding to ns, and the in-plane fast axis indicates the axis in the direction corresponding to nf. d denotes the thickness of the retardation layer. For example, in a case in which the material for the retardation layer is a liquid crystal material, the in-plane retardation (R) is defined by R=Δn×d, where Δn denotes the anisotropy of refractive index of the liquid crystal material. In the present specification, the retardation means an in-plane retardation unless otherwise stated.

In the present specification, the fact that two axes (directions) are orthogonal to each other means that the angle between the two axes is 87° to 93°, and the angle is preferably 89° to 91°, more preferably 89.5° to 90.5°, particularly preferably 90° (perfectly at right angles).

In the present specification, the fact that two axes (directions) are parallel to each other means that the angle between the two axes is 0° to 3°, and the angle is preferably 0° to 1°, more preferably 0° to 0.5°, particularly preferably 0° (perfectly parallel).

In the present specification, the fact that two axes (directions) form an angle of 45° means that the angle between the two axes is 42° to 48°, and the angle is preferably 44° to 46°, more preferably 44.5° to 45.5°, particularly preferably 45°.

### Embodiment 1

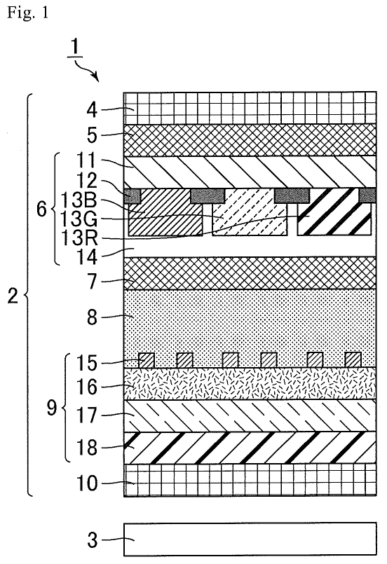

FIG. 1 is a schematic cross-sectional view illustrating a liquid crystal display device and a liquid crystal display panel of Embodiment 1. As illustrated in FIG. 1, a liquid crystal display device 1 includes a liquid crystal display panel 2 and a backlight 3 in order from the observation surface side to the rear surface side.

The method of the backlight 3 is not limited, and examples thereof include an edge light method and a direct method. The kind of the light source of the backlight 3 is not limited, and examples thereof include a light emitting diode (LED) and a cold cathode fluorescent lamp (CCFL).

The liquid crystal display panel 2 includes a first polarizing plate 4, a first λ/4 layer (out-cell retardation layer) 5, a first substrate 6, and a second λ/4 layer (in-cell retardation layer) 7, a liquid crystal layer 8, a second substrate 9, and a second polarizing plate 10 in order from the observation surface side to the rear surface side.

### <First Polarizing Plate and Second Polarizing Plate>

As the first polarizing plate 4 and the second polarizing plate 10, for example, a polarizer (absorption type polarizing plate) obtained by dyeing and adsorbing an anisotropic material such as an iodine complex (or dye) on a polyvinyl alcohol (PVA) film and then performing stretching and alignment and the like can be used.

The transmission axis of the first polarizing plate 4 and the transmission axis of the second polarizing plate 10 are preferably orthogonal to each other. According to such a configuration, the first polarizing plate 4 and the second polarizing plate 10 are disposed in crossed Nicols, and thus a black display state can be effectively realized when a voltage is not applied (a state in which a voltage is not applied between a pixel electrode 15 and a common electrode 17 to be described later).

### <First Substrate>

The first substrate 6 includes a first support base 11, a black matrix 12 which is partially disposed on the surface of the first support base 11 on the liquid crystal layer 8 side (rear surface side), a plurality of color filter layers 13R (red), 13G (green), and 13B (blue), and an overcoat layer 14 which covers the black matrix 12 and the color filter layers 13R, 13G, and 13B. The black matrix 12 is disposed in a lattice shape so as to partition the plurality of color filter layers 13R, 13G, and 13B in the active region and is disposed on the entire surface in the inactive region.

Examples of the first support base 11 include a glass substrate and a plastic substrate.

Examples of the material for the black matrix 12 include a black resist having a light shielding percentage of 99.9% or more (OD value of 3.0 or more).

Examples of the material for the color filter layers 13R, 13G, and 13B include pigment-dispersed color resists. The color combination of the color filter layers is not limited, examples thereof include a combination of red, green, blue, and yellow in addition to a combination of red, green, and blue as illustrated in FIG. 1.

Examples of the material for the overcoat layer 14 include a transparent resin, and among others, a material exhibiting high heat resistance and high chemical resistance is preferable.

A horizontal alignment film may be disposed on the surface (between the first substrate 6 and the second λ/4 layer 7) of the first substrate 6 on the liquid crystal layer 8 side (rear surface side). The horizontal alignment film has a function of aligning liquid crystal molecules present in the vicinity in parallel to the surface. Here, the fact that liquid crystal molecules are aligned parallel to the surface of the horizontal alignment film means that the pre-tilt angle of liquid crystal molecules (tilt angle when a voltage is not applied) is 0° to 5° with respect to the surface of the horizontal alignment film. Examples of the material for the horizontal alignment film include an organic material such as polyimide and a photoisomerization type photoalignment material. The surface of the horizontal alignment film may be subjected to an alignment treatment such as a photoalignment treatment or a rubbing treatment.

### <Second Substrate>

The second substrate 9 includes a second support base 18, a common electrode 17 disposed on the surface of the second support base 18 on the liquid crystal layer 8 side (observation surface side), an insulating film 16 covering the common electrode 17, and the pixel electrode 15 disposed on the surface of the insulating film 16 on the liquid crystal layer 8 side (observation surface side). According to such a configuration, a horizontal electric field (fringe field) is generated in the liquid crystal layer 8 and the alignment of liquid crystal molecules in the liquid crystal layer 8 is controlled as a voltage is applied between the pixel electrode 15 and the common electrode 17 (at the time of voltage application). In other words, the liquid crystal display panel 2 is a liquid crystal display panel in a horizontal electric field mode.

Examples of the second support base 18 include a glass substrate and a plastic substrate.

The common electrode 17 is a planar electrode. According to such a configuration, a common voltage is supplied to the respective pixels of the liquid crystal display panel 2.

Examples of the material for the common electrode 17 include transparent materials (inorganic materials) such as indium tin oxide (ITO) and indium zinc oxide (IZO).

As the material for the insulating film 16, either of an organic insulating material or an inorganic insulating material can be used. Examples of the organic insulating material include polyimide. Examples of the inorganic insulating material include a nitride.

The pixel electrode 15 is an electrode provided with a slit. According to such a configuration, a horizontal electric field (fringe field) is efficiently formed between the pixel electrode 15 and the common electrode 17 when a voltage is applied.

Examples of the material for the pixel electrode 15 include transparent materials (inorganic materials) such as indium tin oxide (ITO) and indium zinc oxide (IZO).

A case in which the liquid crystal display panel 2 is a liquid crystal display panel in a FFS mode (a case in which the second substrate 9 is a thin film transistor array substrate in a FFS mode) is illustrated in FIG. 1, but the liquid crystal display panel 2 may be a liquid crystal display panel in an IPS mode which is the same horizontal electric field mode. According to the liquid crystal display panel in an IPS mode, a horizontal electric field is generated in the liquid crystal layer 8 and the alignment of liquid crystal molecules in the liquid crystal layer 8 is controlled as a voltage is applied between a pair of comb electrodes disposed on the second substrate 9 (at the time of voltage application).

A horizontal alignment film may be disposed on the surface of the second substrate 9 on the liquid crystal layer 8 side (observation surface side).

### <Liquid Crystal Layer>

The liquid crystal molecules in the liquid crystal layer 8 are homogeneously aligned in a state in which a voltage is not applied between the pixel electrode 15 and the common electrode 17 (when a voltage is not applied). Here, the fact that liquid crystal molecules are homogeneously aligned means that the pre-tilt angle of liquid crystal molecules (tilt angle when a voltage is not applied) is 0° to 5° with respect to the surface of the second substrate 9.

Examples of the material for the liquid crystal layer 8 include a negative liquid crystal material having negative anisotropy of dielectric constant (Δε<0).

It is preferable that the alignment direction of the liquid crystal molecules in the liquid crystal layer 8 and the transmission axis of either one of the first polarizing plate 4 or the second polarizing plate 10 are parallel to each other in a state in which a voltage is not applied between the pixel electrode 15 and the common electrode 17 (when a voltage is not applied). According to such a configuration, a black display state can be effectively realized when a voltage is applied.

### <First λ/4 Layer and Second λ/4 Layer>

Examples of the material for the first λ/4 layer 5 and the second λ/4 layer 7 include a photopolymerizable liquid crystal material. Examples of the structure of the photopolymerizable liquid crystal material include a structure having a photopolymerizable group such as an acrylate group or a methacrylate group at the terminal of the skeleton of the liquid crystal molecule. According to such a material, it is likely to attain a flattening effect by which the level difference of the ground (object to be coated) is flattened. In the present embodiment, the second λ/4 layer 7 also functions as a flattening layer of the first substrate 6, and thus the space (the thickness of the liquid crystal layer 8: cell gap) between the second λ/4 layer 7 (first substrate 6) and the second substrate 9 is uniform.

The photopolymerizable liquid crystal material functions as a λ/4 layer, for example, by the following method. First, the photopolymerizable liquid crystal material is dissolved in an organic solvent such as propylene glycol monomethyl ether acetate (PGMEA). Next, the obtained solution is applied onto the surface of the first substrate 6 on the liquid crystal layer 8 side (rear surface side) to form a film of solution. Thereafter, this film of solution is subjected to pre-baking, light irradiation (for example, ultraviolet irradiation), and post-baking in the stated order, as a result, the photopolymerizable liquid crystal material functions as the second λ/4 layer 7. The first λ/4 layer 5 may be also obtained by being formed on the surface of a substrate (for example, polyethylene terephthalate (PET) film) by the same method as that for the second λ/4 layer 7 and pasted to the surface of the first substrate 6 (first support base 11) on the opposite side (observation surface side) to the liquid crystal layer 8 with an adhesive and the like interposed therebetween.

As the first λ/4 layer 5, a polymer film which is subjected to a stretching treatment and is generally used in the field of liquid crystal display devices can also be used since this can be utilized by being pasted to the first substrate 6. Examples of the material for the polymer film include cycloolefin polymer, polycarbonate, polysulfone, polyethersulfone, polyethylene terephthalate, polyethylene, polyvinyl alcohol, norbornene, triacetyl cellulose, and diacetyl cellulose, and cycloolefin polymer is preferable among these. The λ/4 layer formed of cycloolefin polymer exhibits excellent durability and has an advantage that a change in retardation is small when being exposed to a severe environment such as a high temperature environment or a high temperature and high humidity environment for a long period of time.

The in-plane slow axis of the first λ/4 layer 5 forms an angle of 45° with the transmission axis of the first polarizing plate 4. According to such a configuration, a configuration is realized in which the circularly polarizing plate in which the first polarizing plate 4 and the first λ/4 layer 5 are laminated is disposed on the observation surface side of the liquid crystal display panel 2. Hence, incident light (for example, external light) from the observation surface side of the liquid crystal display panel 2 is converted into circularly polarized light when passing through the circularly polarizing plate and reaches the first substrate 6, thus reflection from the first substrate 6 (layer disposed on the opposite side (observation surface side) to the liquid crystal layer 8 rather than the overcoat layer 14) is suppressed by the antireflection effect of the circularly polarizing plate, and the visibility in the bright place increases. When the circularly polarizing plate is formed by laminating the first polarizing plate 4 and the first λ/4 layer 5, it is preferable to use a roll-to-roll method from the viewpoint of increasing the producibility.

The in-plane slow axis of the first λ/4 layer 5 is orthogonal to the in-plane slow axis of the second λ/4 layer 7. According to such a configuration, the first λ/4 layer 5 and the second λ/4 layer 7 cancel the retardation therebetween with respect to incident light from the rear surface side of the liquid crystal display panel 2 (for example, incident light from the backlight 3), and thus a state in which both of these are optically substantially absent is realized. In other words, a configuration is realized which is optically equivalent to a conventional liquid crystal display panel in a horizontal electric field mode with respect to incident light from the rear surface side of the liquid crystal display panel 2. Hence, it is possible to realize display by a horizontal electric field mode using a circularly polarizing plate. Here, the first λ/4 layer 5 and the second λ/4 layer 7 are preferably composed of the same material. By this, the first λ/4 layer 5 and the second λ/4 layer 7 can cancel the retardation therebetween including wavelength dispersion.

A photo spacer may be disposed on the surface of the second λ/4 layer 7 on the liquid crystal layer 8 side (rear surface side). According to the photo spacer, the space (thickness of the liquid crystal layer 8: cell gap) between the second λ/4 layer 7 (first substrate 6) and the second substrate 9 can be effectively maintained. The photo spacer preferably overlaps the black matrix 12. According to such a configuration, when the liquid crystal display panel 2 is viewed from the observation surface side, the photo spacer is hidden by the black matrix 12 and thus is not visually recognized.

Next, the relation between the first substrate 6 and the second λ/4 layer 7 will be described below.

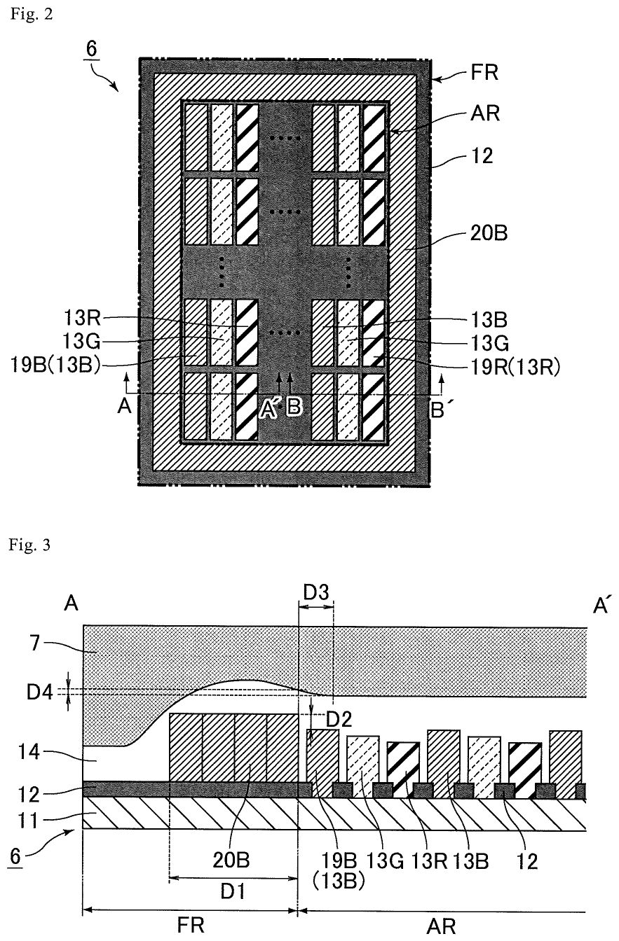

FIG. 2 is a schematic plan view illustrating a state in which the first substrate and the second λ/4 layer of the liquid crystal display panel of Embodiment 1 are viewed from the liquid crystal layer side (rear surface side). As illustrated in FIG. 2, the first substrate 6 includes color filter layers 13R, 13G, and 13B in the active region AR in which an image is displayed. In the present specification, the color filter layer located at the end portion of the active region AR is referred to as an “edge color filter layer”, an edge color filter layer 19B (blue: color filter layer 13B) is located at the left end portion of the active region AR and an edge color filter layer 19R (red: color filter layer 13R) is located at the right end portion of the active region AR. Meanwhile, the first substrate 6 includes a dummy color filter layer 20B (blue) in the inactive region (frame region) FR surrounding the active region AR. The dummy color filter layer 20B can be formed by the same process as that for the color filter layer 13B (can be simultaneously formed) and, for example, may have the same composition as that of the color filter layer 13B and be formed in the same thickness as that of the color filter layer 13B. The dummy color filter layer 20B may be disposed on the entire periphery of the inactive region FR as illustrated in FIG. 2 or may be disposed at a part of the inactive region FR but is preferably disposed on the entire periphery of the inactive region FR.

In FIG. 2, the overcoat layer 14 and the second λ/4 layer 7 are not illustrated since these are transparent but are actually disposed over the entire active region AR and inactive region FR.

FIG. 3 is a schematic cross-sectional view illustrating a portion corresponding to a line segment A-A′ in FIG. 2. In FIG. 3, the lower side corresponds to the observation surface side (the opposite side to the liquid crystal layer 8) and the upper side corresponds to the rear surface side (the liquid crystal layer 8 side). As illustrated in FIG. 3, the black matrix 12 and the dummy color filter layer 20B are disposed in the stated order from the observation surface side to the rear surface side in the inactive region FR at the left end portion of the first substrate 6. The dummy color filter layer 20B overlaps the black matrix 12 and is adjacent to the edge color filter layer 19B. The overcoat layer 14 directly covers the color filter layers 13R, 13G, and 13B (19B) and the black matrix 12 in the active region AR and directly covers the dummy color filter layer 20B and the black matrix 12 in the inactive region FR. The second λ/4 layer 7 overlaps the boundary between the edge color filter layer 19B and the dummy color filter layer 20B.

The level difference D2 between the surface of the edge color filter layer 19B and the surface of the dummy color filter layer 20B is 1.2 μm or less. This suppresses the difference between the thickness of the overcoat layer 14 at the end portion of the active region AR and the thickness thereof at the central portion of the active region AR. In FIG. 3, the thickness of the overcoat layer 14 in the region of the width D3 from the end portion of the active region AR is thicker than that at the central portion of the active region AR by D4 at the maximum. However, according to the present embodiment, the thickness change D4, which is the difference between the thickness at the end portion of the active region AR and the thickness at the central portion of the active region AR, of the overcoat layer 14 is suppressed as compared with the conventional case. The level difference D2 is preferably 0.8 μm or less from the viewpoint of decreasing the thickness change D4 of the overcoat layer 14. Here, the thickness of the overcoat layer 14 refers to the distance from the surface of the color filter layer (the color filter layer 13B in FIG. 3) having the thickest thickness among the color filter layers 13R, 13G, and 13B to the surface of the overcoat layer 14.

As a result of the above, the thickness of the second λ/4 layer 7 at the end portion of the active region AR is thinner than that at the central portion of the active region AR by the thickness change D4 of the overcoat layer 14. In the present embodiment, the thickness change D4 of the overcoat layer 14 is suppressed and thus the difference between the thickness of the second λ/4 layer 7 at the end portion of the active region AR and the thickness thereof at the central portion of the active region AR is also suppressed. Hence, the difference between the in-plane retardation of the second λ/4 layer 7 at the end portion of the active region AR and the in-plane retardation thereof at the central portion of the active region AR is suppressed, and thus light leakage at the end portion of the active region AR in the black display state is suppressed.

The width D1 of the dummy color filter layer 20B is preferably 75 μm or more, more preferably 100 μm or more from the viewpoint of decreasing the thickness change D4 of the overcoat layer 14. The dummy color filter layer 20B preferably does not protrude from the black matrix 12 in the inactive region FR. In other words, the width D1 of the dummy color filter layer 20B is preferably equal to or less than the width of the black matrix 12 in the inactive region FR. From such a viewpoint, the upper limit value of the width D1 of the dummy color filter layer 20B may be, for example, 680 μm. In a case in which the width of the black matrix 12 in the inactive region FR is, for example, 680 μm, the liquid crystal display panel 2 is classified as a so-called narrow frame liquid crystal display panel.

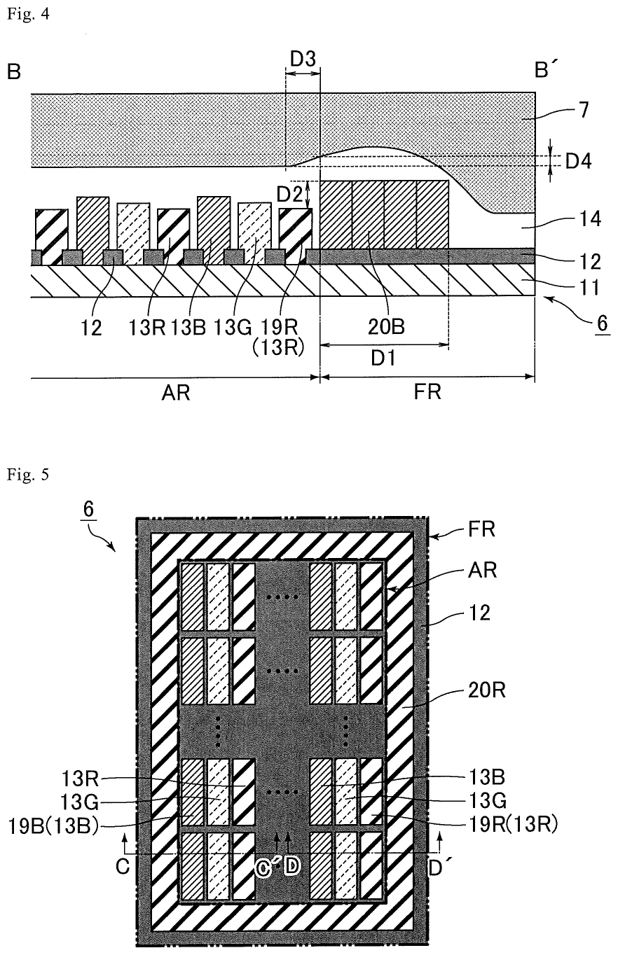

FIG. 4 is a schematic cross-sectional view illustrating a portion corresponding to a line segment B-B′ in FIG. 2. In FIG. 4, the lower side corresponds to the observation surface side (the opposite side to the liquid crystal layer 8) and the upper side corresponds to the rear surface side (the liquid crystal layer 8 side). The state illustrated in FIG. 4 is the same as the state illustrated in FIG. 3 except the disposition order of the color filter layers from the active region AR side to the inactive region FR side, and thus the description of overlapping points is appropriately omitted. As illustrated in FIG. 4, the black matrix 12 and the dummy color filter layer 20B are disposed in the stated order from the observation surface side to the rear surface side in the inactive region FR at the right end portion of the first substrate 6.

The dummy color filter layer 20B overlaps the black matrix 12 and is adjacent to the edge color filter layer 19R. The overcoat layer 14 directly covers the color filter layers 13R (19R), 13G, and 13B and the black matrix 12 in the active region AR and directly covers the dummy color filter layer 20B and the black matrix 12 in the inactive region FR. The second λ/4 layer 7 overlaps the boundary between the edge color filter layer 19R and the dummy color filter layer 20B.

The level difference D2 between the surface of the edge color filter layer 19R and the surface of the dummy color filter layer 20B is 1.2 μm or less. This suppresses the difference between the thickness of the overcoat layer 14 at the end portion of the active region AR and the thickness thereof at the central portion of the active region AR. In FIG. 4, the thickness of the overcoat layer 14 in the region of the width D3 from the end portion of the active region AR is thicker than that at the central portion of the active region AR by D4 at the maximum.

However, according to the present embodiment, the thickness change D4, which is the difference between the thickness at the end portion of the active region AR and the thickness at the central portion of the active region AR, of the overcoat layer 14 is suppressed as compared with the conventional case. The level difference D2 is preferably 0.8 μm or less from the viewpoint of decreasing the thickness change D4 of the overcoat layer 14.

As a result of the above, the thickness of the second λ/4 layer 7 at the end portion of the active region AR is thinner than that at the central portion of the active region AR by the thickness change D4 of the overcoat layer 14. In the present embodiment, the thickness change D4 of the overcoat layer 14 is suppressed and thus the difference between the thickness of the second λ/4 layer 7 at the end portion of the active region AR and the thickness thereof at the central portion of the active region AR is also suppressed. Hence, the difference between the in-plane retardation of the second λ/4 layer 7 at the end portion of the active region AR and the in-plane retardation thereof at the central portion of the active region AR is suppressed, and thus light leakage at the end portion of the active region AR in the black display state is suppressed.

In the above, the relation between the first substrate 6 and the second λ/4 layer 7 has been described by focusing on the left end portion and right end portion of the liquid crystal display panel 2, but the upper end portion and lower end portion of the liquid crystal display panel 2 can also be described in the same manner when it is considered that the kind (color, thickness, and the like) of edge color filter layer varies depending on the position.

### Embodiment 2

The liquid crystal display device and liquid crystal display panel of the Embodiment 2 are the same as the liquid crystal display device and liquid crystal display panel of Embodiment 1 except the kind of dummy color filter layer, and thus the description of overlapping points is appropriately omitted.

FIG. 5 is a schematic plan view illustrating a state in which a first substrate and a second λ/4 layer of the liquid crystal display panel of Embodiment 2 are viewed from the liquid crystal layer side (rear surface side). As illustrated in FIG. 5, a first substrate 6 includes color filter layers 13R, 13G, and 13B in the active region AR in which an image is displayed. Among these color filter layers, an edge color filter layer 19B (blue: color filter layer 13B) is located at the left end portion of the active region AR and an edge color filter layer 19R (red: color filter layer 13R) is located at the right end portion of the active region AR. Meanwhile, the first substrate 6 includes a dummy color filter layer 20R (red) in the inactive region (frame region) FR surrounding the active region AR. The dummy color filter layer 20R can be formed by the same process as that for the color filter layer 13R (can be simultaneously formed) and, for example, may have the same composition as that of the color filter layer 13R and be formed in the same thickness as that of the color filter layer 13R. The dummy color filter layer 20R may be disposed on the entire periphery of the inactive region FR as illustrated in FIG. 5 or may be disposed at a part of the inactive region FR but is preferably disposed on the entire periphery of the inactive region FR.

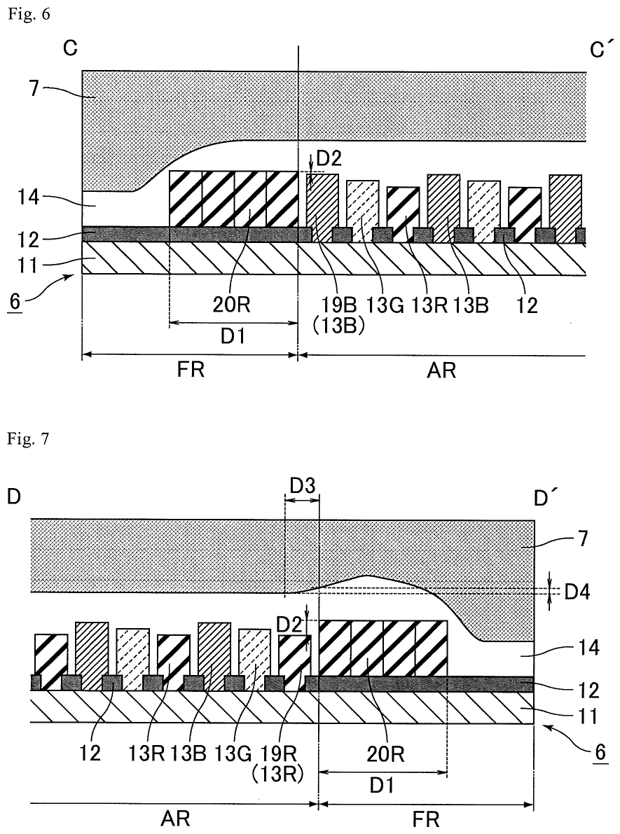

FIG. 6 is a schematic cross-sectional view illustrating a portion corresponding to a line segment C-C′ in FIG. 5. In FIG. 6, the lower side corresponds to the observation surface side (the opposite side to the liquid crystal layer 8) and the upper side corresponds to the rear surface side (the liquid crystal layer 8 side). As illustrated in FIG. 6, the black matrix 12 and the dummy color filter layer 20R are disposed in the stated order from the observation surface side to the rear surface side in the inactive region FR at the left end portion of the first substrate 6. The dummy color filter layer 20R overlaps the black matrix 12 and is adjacent to the edge color filter layer 19B. The overcoat layer 14 directly covers the color filter layers 13R, 13G, and 13B (19B) and the black matrix 12 in the active region AR and directly covers the dummy color filter layer 20R and the black matrix 12 in the inactive region FR. The second λ/4 layer 7 overlaps the boundary between the edge color filter layer 19B and the dummy color filter layer 20R.

The level difference D2 between the surface of the edge color filter layer 19B and the surface of the dummy color filter layer 20R is 1.2 μm or less. This suppresses the difference between the thickness of the overcoat layer 14 at the end portion of the active region AR and the thickness thereof at the central portion of the active region AR. In FIG. 6, the thickness of the overcoat layer 14 in the region near the end portion of the active region AR is equal to that at the central portion of the active region AR and is more uniform as compared with that in Embodiment 1 (FIG. 3). The color of the dummy color filter layer is preferably the same as the color of the color filter layer having the thinnest thickness among the plurality of color filter layers (disposed in the active region) from the viewpoint of increasing the thickness uniformity of the overcoat layer 14 in this manner. In the present embodiment, the level difference D2 is suppressed, and as a result, the thickness uniformity of the overcoat layer 14 is increased as the color of the dummy color filter layer is set to red which is the color of the color filter layer 13R having the thinnest thickness among the color filter layers 13R, 13G, and 13B. Here, the magnitude relation between the thicknesses of the color filter layers 13R, 13G, and 13B varies depending on the chromaticity specifications of the liquid crystal display panel 2, and thus the color filter layer 13R may have the thinnest thickness as in the present embodiment, the color filter layer 13G may have the thinnest thickness, or the color filter layer 13B may have the thinnest thickness.

As a result of the above, the thickness of the second λ/4 layer 7 at the end portion of the active region AR is equal to that at the central portion of the active region AR. In other words, according to the present embodiment, the difference between the thickness of the second λ/4 layer 7 at the end portion of the active region AR and the thickness thereof at the central portion of the active region AR is sufficiently suppressed. Hence, the difference between the in-plane retardation of the second λ/4 layer 7 at the end portion of the active region AR and the in-plane retardation thereof at the central portion of the active region AR is sufficiently suppressed, and thus light leakage at the end portion of the active region AR in the black display state is further suppressed than in Embodiment 1 (FIG. 3).

FIG. 7 is a schematic cross-sectional view illustrating a portion corresponding to a line segment D-D′ in FIG. 5. In FIG. 7, the lower side corresponds to the observation surface side (the opposite side to the liquid crystal layer 8) and the upper side corresponds to the rear surface side (the liquid crystal layer 8 side). The state illustrated in FIG. 7 is the same as the state illustrated in FIG. 6 except the disposition order of the color filter layers from the active region AR side to the inactive region FR side, and thus the description of overlapping points is appropriately omitted. As illustrated in FIG. 7, the black matrix 12 and the dummy color filter layer 20R are disposed in the stated order from the observation surface side to the rear surface side in the inactive region FR at the right end portion of the first substrate 6. The dummy color filter layer 20R overlaps the black matrix 12 and is adjacent to the edge color filter layer 19R. The overcoat layer 14 directly covers the color filter layers 13R (19R), 13G, and 13B and the black matrix 12 in the active region AR and directly covers the dummy color filter layer 20R and the black matrix 12 in the inactive region FR.

The second λ/4 layer 7 overlaps the boundary between the edge color filter layer 19R and the dummy color filter layer 20R.

The level difference D2 between the surface of the edge color filter layer 19R and the surface of the dummy color filter layer 20R is 1.2 μm or less. This suppresses the difference between the thickness of the overcoat layer 14 at the end portion of the active region AR and the thickness thereof at the central portion of the active region AR. In FIG. 7, the thickness of the overcoat layer 14 in the region of the width D3 from the end portion of the active region AR is thicker than that at the central portion of the active region AR by D4 at the maximum. However, according to the present embodiment, the thickness change D4, which is the difference between the thickness at the end portion of the active region AR and the thickness at the central portion of the active region AR, of the overcoat layer 14 is suppressed as compared with the conventional case.

As a result of the above, the thickness of the second λ/4 layer 7 at the end portion of the active region AR is thinner than that at the central portion of the active region AR by the thickness change D4 of the overcoat layer 14. In the present embodiment, the thickness change D4 of the overcoat layer 14 is suppressed and thus the difference between the thickness of the second λ/4 layer 7 at the end portion of the active region AR and the thickness thereof at the central portion of the active region AR is also suppressed. Hence, the difference between the in-plane retardation of the second λ/4 layer 7 at the end portion of the active region AR and the in-plane retardation thereof at the central portion of the active region AR is suppressed, and thus light leakage at the end portion of the active region AR in the black display state is suppressed.

### Embodiment 3

The liquid crystal display device and liquid crystal display panel of Embodiment 3 are the same as the liquid crystal display device and liquid crystal display panel of Embodiment 1 except that the color of the edge color filter layer is set to the same color at the entire peripheral portion (entire peripheral) of the active region and the width of the dummy color filter layer is decreased, and thus the description of overlapping points is appropriately omitted.

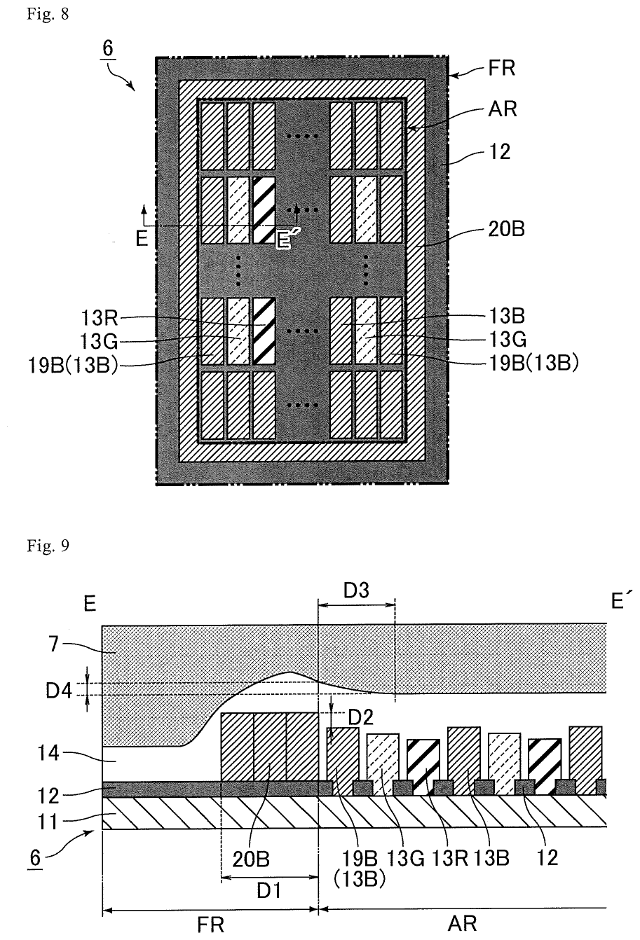

FIG. 8 is a schematic plan view illustrating a state in which a first substrate and a second λ/4 layer of the liquid crystal display panel of Embodiment 3 are viewed from the liquid crystal layer side (rear surface side). As illustrated in FIG. 8, a first substrate 6 includes color filter layers 13R, 13G, and 13B in the active region AR in which an image is displayed. Among these color filter layers, an edge color filter layer 19B (blue: color filter layer 13B) is located at the left end portion of the active region AR and an edge color filter layer 19B (blue: color filter layer 13B) is located at the right end portion of the active region AR. The edge color filter layer 19B is located at the entire peripheral portion including the upper end portion and lower end portion of the active region AR in addition to the left end portion and right end portion of the active region AR. Meanwhile, the first substrate 6 includes a dummy color filter layer 20B (blue) in the inactive region (frame region) FR surrounding the active region AR.

FIG. 9 is a schematic cross-sectional view illustrating a portion corresponding to a line segment E-E′ in FIG. 8. In FIG. 9, the lower side corresponds to the observation surface side (the opposite side to the liquid crystal layer 8) and the upper side corresponds to the rear surface side (the liquid crystal layer 8 side). As illustrated in FIG. 9, a black matrix 12 and the dummy color filter layer 20B are disposed in the stated order from the observation surface side to the rear surface side in the inactive region FR at the left end portion of the first substrate 6. The dummy color filter layer 20B overlaps the black matrix 12 and is adjacent to the edge color filter layer 19B. The width D1 of the dummy color filter layer 20B is narrower than that in Embodiment 1 (FIG. 3). The overcoat layer 14 directly covers the color filter layers 13R, 13G, and 13B (19B) and the black matrix 12 in the active region AR and directly covers the dummy color filter layer 20B and the black matrix 12 in the inactive region FR. The second λ/4 layer 7 overlaps the boundary between the edge color filter layer 19B and the dummy color filter layer 20B.

The level difference D2 between the surface of the edge color filter layer 19B and the surface of the dummy color filter layer 20B is 1.2 μm or less. This suppresses the difference between the thickness of the overcoat layer 14 at the end portion of the active region AR and the thickness thereof at the central portion of the active region AR. In FIG. 9, the thickness of the overcoat layer 14 in the region of the width D3 from the end portion of the active region AR is thicker than that at the central portion of the active region AR by D4 at the maximum. However, according to the present embodiment, the thickness change D4, which is the difference between the thickness at the end portion of the active region AR and the thickness at the central portion of the active region AR, of the overcoat layer 14 is suppressed as compared with the conventional case.

As a result of the above, the thickness of the second λ/4 layer 7 at the end portion of the active region AR is thinner than that at the central portion of the active region AR by the thickness change D4 of the overcoat layer 14. In the present embodiment, the thickness change D4 of the overcoat layer 14 is suppressed and thus the difference between the thickness of the second λ/4 layer 7 at the end portion of the active region AR and the thickness thereof at the central portion of the active region AR is also suppressed. Hence, the difference between the in-plane retardation of the second λ/4 layer 7 at the end portion of the active region AR and the in-plane retardation thereof at the central portion of the active region AR is suppressed, and thus light leakage at the end portion of the active region AR in the black display state is suppressed.

In the present embodiment, the width D1 of the dummy color filter layer 20B is narrower than that in Embodiment 1 (FIG. 3), and thus the width D3 of the region in which the thickness of the overcoat layer 14 changes and the thickness change D4 of the overcoat layer 14 are greater than those in Embodiment 1 (FIG. 3). As a result, the width of the region in which the thickness of the second λ/4 layer 7 changes and the thickness change of the second λ/4 layer 7 are greater than those in Embodiment 1 (FIG. 3). Meanwhile, in the present embodiment, a blue edge color filter layer 19B having a low visual sensitivity is disposed as the edge color filter layer. For this reason, light leakage at the end portion of the active region AR in the black display state is hardly visually recognized even in a case in which the width D1 of the dummy color filter layer 20B is narrow. The color of the edge color filter layer is preferably blue from such a viewpoint. The edge color filter layer 19B may be disposed at the entire peripheral portion (entire periphery) of the active region AR as illustrated in FIG. 8 or may be disposed at a part of the peripheral portion of the active region AR but is preferably disposed at the entire peripheral portion of the active region AR.

The description of the cross section at the right end portion of the first substrate 6 in FIG. 8 is the same as the description of that in FIG. 9 described above.

### Embodiment 4

The liquid crystal display device and liquid crystal display panel of the Embodiment 4 are the same as the liquid crystal display device and liquid crystal display panel of Embodiment 1 except that an overcoat layer is not disposed, and thus the description of overlapping points is appropriately omitted.

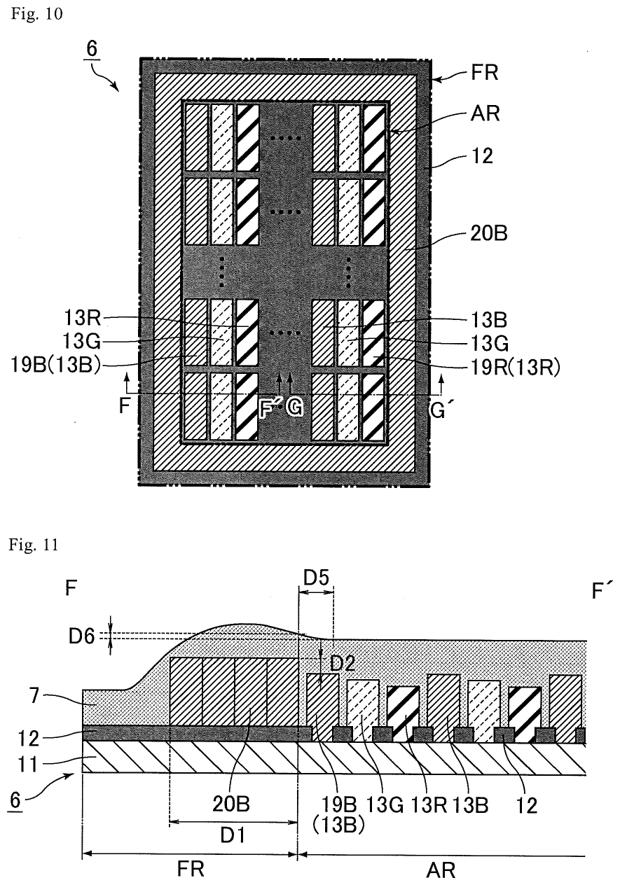

FIG. 10 is a schematic plan view illustrating a state in which a first substrate and a second λ/4 layer of the liquid crystal display panel of Embodiment 4 are viewed from the liquid crystal layer side (rear surface side). As illustrated in FIG. 10, a first substrate 6 includes color filter layers 13R, 13G, and 13B in the active region AR in which an image is displayed. Among these color filter layers, an edge color filter layer 19B (blue: color filter layer 13B) is located at the left end portion of the active region AR and an edge color filter layer 19R (red: color filter layer 13R) is located at the right end portion of the active region AR. Meanwhile, the first substrate 6 includes a dummy color filter layer 20B (blue) in the inactive region (frame region) FR surrounding the active region AR.

FIG. 11 is a schematic cross-sectional view illustrating a portion corresponding to a line segment F-F′ in FIG. 10. In FIG. 11, the lower side corresponds to the observation surface side (the opposite side to the liquid crystal layer 8) and the upper side corresponds to the rear surface side (the liquid crystal layer 8 side). As illustrated in FIG. 11, a black matrix 12 and the dummy color filter layer 20B are disposed in the stated order from the observation surface side to the rear surface side in the inactive region FR at the left end portion of the first substrate 6. The dummy color filter layer 20B overlaps the black matrix 12 and is adjacent to the edge color filter layer 19B. The second λ/4 layer 7 directly covers the color filter layers 13R, 13G, and 13B (19B) and the black matrix 12 in the active region AR and directly covers the dummy color filter layer 20B and the black matrix 12 in the inactive region FR. The second λ/4 layer 7 overlaps the boundary between the edge color filter layer 19B and the dummy color filter layer 20B.

The level difference D2 between the surface of the edge color filter layer 19B and the surface of the dummy color filter layer 20B is 1.2 μm or less. This suppresses the difference between the thickness of the second λ/4 layer 7 at the end portion of the active region AR and the thickness thereof at the central portion of the active region AR. In FIG. 11, the thickness of the second λ/4 layer 7 in the region of the width D5 from the end portion of the active region AR is thicker than that at the central portion of the active region AR by D6 at the maximum. However, according to the present embodiment, the thickness change D6, which is the difference between the thickness at the end portion of the active region AR and the thickness at the central portion of the active region AR, of the second λ/4 layer 7 is suppressed as compared with the conventional case. Hence, the difference between the in-plane retardation of the second λ/4 layer 7 at the end portion of the active region AR and the in-plane retardation thereof at the central portion of the active region AR is suppressed, and thus light leakage at the end portion of the active region AR in the black display state is suppressed. The level difference D2 is preferably 0.8 μm or less from the viewpoint of decreasing the thickness change D6 of the second λ/4 layer 7. Here, the thickness of the second λ/4 layer 7 refers to the distance from the surface of the color filter layer (the color filter layer 13B in FIG. 11) having the thickest thickness among the color filter layers 13R, 13G, and 13B to the surface of the second λ/4 layer 7.

The width D1 of the dummy color filter layer 20B is preferably 75 μm or more, more preferably 100 μm or more from the viewpoint of decreasing the thickness change D6 of the second λ/4 layer 7.

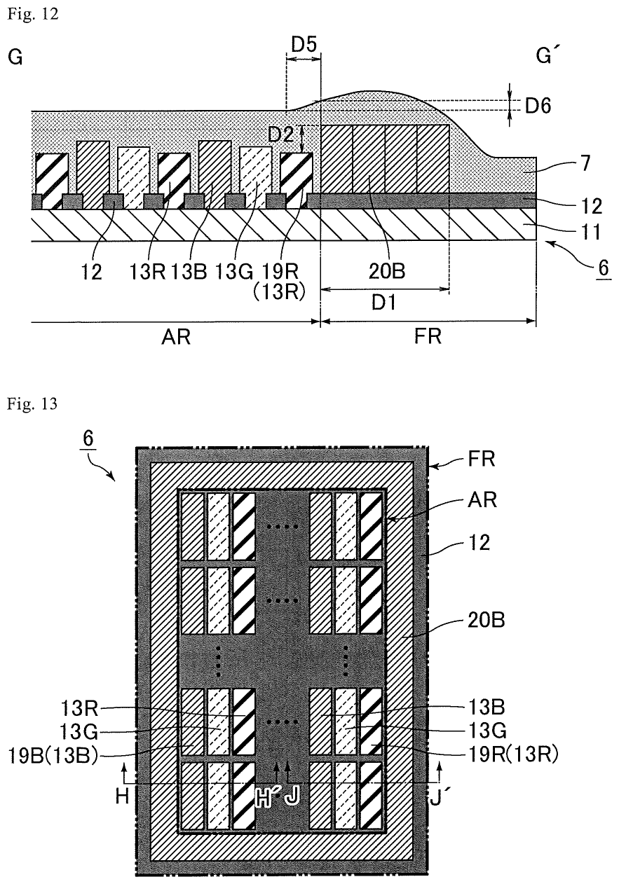

FIG. 12 is a schematic cross-sectional view illustrating a portion corresponding to a line segment G-G′ in FIG. 10. In FIG. 12, the lower side corresponds to the observation surface side (the opposite side to the liquid crystal layer 8) and the upper side corresponds to the rear surface side (the liquid crystal layer 8 side). The state illustrated in FIG. 12 is the same as the state illustrated in FIG. 11 except the disposition order of the color filter layers from the active region AR side to the inactive region FR side, and thus the description of overlapping points is appropriately omitted. As illustrated in FIG. 12, the black matrix 12 and the dummy color filter layer 20B are disposed in the stated order from the observation surface side to the rear surface side in the inactive region FR at the right end portion of the first substrate 6. The dummy color filter layer 20B overlaps the black matrix 12 and is adjacent to the edge color filter layer 19R. The second λ/4 layer 7 directly covers the color filter layers 13R (19R), 13G, and 13B and the black matrix 12 in the active region AR and directly covers the dummy color filter layer 20B and the black matrix 12 in the inactive region FR. The second λ/4 layer 7 overlaps the boundary between the edge color filter layer 19R and the dummy color filter layer 20B.

The level difference D2 between the surface of the edge color filter layer 19R and the surface of the dummy color filter layer 20B is 1.2 μm or less. This suppresses the difference between the thickness of the second λ/4 layer 7 at the end portion of the active region AR and the thickness thereof at the central portion of the active region AR. In FIG. 12, the thickness of the second λ/4 layer 7 in the region of the width D5 from the end portion of the active region AR is thicker than that at the central portion of the active region AR by D6 at the maximum. However, according to the present embodiment, the thickness change D6, which is the difference between the thickness at the end portion of the active region AR and the thickness at the central portion of the active region AR, of the second λ/4 layer 7 is suppressed as compared with the conventional case. Hence, the difference between the in-plane retardation of the second λ/4 layer 7 at the end portion of the active region AR and the in-plane retardation thereof at the central portion of the active region AR is suppressed, and thus light leakage at the end portion of the active region AR in the black display state is suppressed. The level difference D2 is preferably 0.8 μm or less from the viewpoint of decreasing the thickness change D6 of the second λ/4 layer 7.

According to the present embodiment, light leakage at the end portion of the active region AR in the black display state is suppressed even in a case in which the overcoat layer 14 is not disposed in the first substrate 6.

### Embodiment 5

The liquid crystal display device and liquid crystal display panel of the Embodiment 5 are the same as the liquid crystal display device and liquid crystal display panel of Embodiment 1 except that the thickness of dummy color filter layer is decreased, and thus the description of overlapping points is appropriately omitted.

FIG. 13 is a schematic plan view illustrating a state in which a first substrate and a second λ/4 layer of the liquid crystal display panel of Embodiment 5 are viewed from the liquid crystal layer side (rear surface side). As illustrated in FIG. 13, a first substrate 6 includes color filter layers 13R, 13G, and 13B in the active region AR in which an image is displayed. Among these color filter layers, an edge color filter layer 19B (blue: color filter layer 13B) is located at the left end portion of the active region AR and an edge color filter layer 19R (red: color filter layer 13R) is located at the right end portion of the active region AR. Meanwhile, the first substrate 6 includes a dummy color filter layer 20B (blue) in the inactive region (frame region) FR surrounding the active region AR.

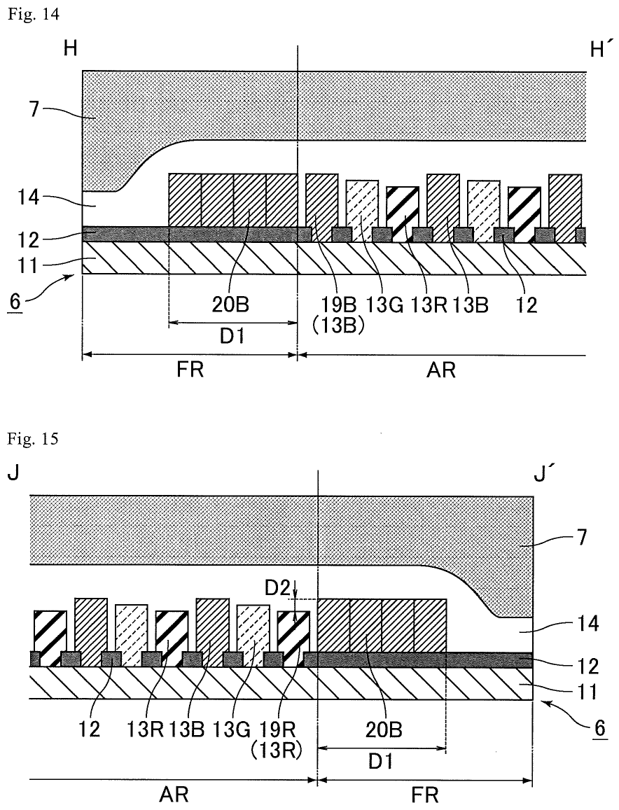

FIG. 14 is a schematic cross-sectional view illustrating a portion corresponding to a line segment H-H′ in FIG. 13. In FIG. 14, the lower side corresponds to the observation surface side (the opposite side to the liquid crystal layer 8) and the upper side corresponds to the rear surface side (the liquid crystal layer 8 side). As illustrated in FIG. 14, a black matrix 12 and the dummy color filter layer 20B are disposed in the stated order from the observation surface side to the rear surface side in the inactive region FR at the left end portion of the first substrate 6. The dummy color filter layer 20B overlaps the black matrix 12 and is adjacent to the edge color filter layer 19B. The second λ/4 layer 7 directly covers the color filter layers 13R, 13G, and 13B (19B) and the black matrix 12 in the active region AR and directly covers the dummy color filter layer 20B and the black matrix 12 in the inactive region FR. The second λ/4 layer 7 overlaps the boundary between the edge color filter layer 19B and the dummy color filter layer 20B.

In the present embodiment, the thickness of the dummy color filter layer 20B in the inactive region FR is thinner than the thickness of the color filter layer 13B (19B) in the active region AR. In addition, in the present embodiment, the thickness of the dummy color filter layer 20B is thinner than that in Embodiment 1 (FIG. 3). For this reason, in the present embodiment, the level difference between the surface of the edge color filter layer 19B and the surface of the dummy color filter layer 20B is further suppressed than in Embodiment 1 (FIG. 3). In FIG. 14, there is no level difference between the surface of the edge color filter layer 19B and the surface of the dummy color filter layer 20B. For this reason, the thickness of the overcoat layer 14 in the region near the end portion of the active region AR is equal to that at the central portion of the active region AR and is more uniform as compared with that in Embodiment 1 (FIG. 3).

As a result of the above, the thickness of the second λ/4 layer 7 at the end portion of the active region AR is equal to that at the central portion of the active region AR. In other words, according to the present embodiment, the difference between the thickness of the second λ/4 layer 7 at the end portion of the active region AR and the thickness thereof at the central portion of the active region AR is sufficiently suppressed. Hence, the difference between the in-plane retardation of the second λ/4 layer 7 at the end portion of the active region AR and the in-plane retardation thereof at the central portion of the active region AR is sufficiently suppressed, and thus light leakage at the end portion of the active region AR in the black display state is further suppressed than in Embodiment 1 (FIG. 3).

As the present embodiment, a state in which the thickness of the dummy color filter layer 20B in the inactive region FR is thinner than the thickness of the color filter layer 13B (19B) in the active region AR can be realized by, for example, using a halftone mask in the exposure step when forming these layers. As the halftone mask, a photomask of which the part corresponding to the position of the dummy color filter layer 20B in the inactive region FR has a halftone shape, that is, which is in a state of partially transmitting light (for example, ultraviolet light) may be used. When such a halftone mask is used, it is possible to decrease the light intensity (exposure amount) irradiated to the inactive region FR in one time of exposure to be less than the light intensity (exposure amount) irradiated to the active region AR and thus to decrease the thickness of the dummy color filter layer 20B to be thinner than the thickness of the color filter layer 13B (19B) after the development step.

FIG. 15 is a schematic cross-sectional view illustrating a portion corresponding to a line segment J-J′ in FIG. 13. In FIG. 15, the lower side corresponds to the observation surface side (the opposite side to the liquid crystal layer 8) and the upper side corresponds to the rear surface side (the liquid crystal layer 8 side). The state illustrated in FIG. 15 is the same as the state illustrated in FIG. 14 except the disposition order of the color filter layers from the active region AR side to the inactive region FR side, and thus the description of overlapping points is appropriately omitted. As illustrated in FIG. 15, the black matrix 12 and the dummy color filter layer 20B are disposed in the stated order from the observation surface side to the rear surface side in the inactive region FR at the right end portion of the first substrate 6. The dummy color filter layer 20B overlaps the black matrix 12 and is adjacent to the edge color filter layer 19R. The overcoat layer 14 directly covers the color filter layers 13R (19R), 13G, and 13B and the black matrix 12 in the active region AR and directly covers the dummy color filter layer 20B and the black matrix 12 in the inactive region FR. The second λ/4 layer 7 overlaps the boundary between the edge color filter layer 19R and the dummy color filter layer 20B.

The level difference D2 between the surface of the edge color filter layer 19R and the surface of the dummy color filter layer 20B is 1.2 μm or less. This suppresses the difference between the thickness of the overcoat layer 14 at the end portion of the active region AR and the thickness thereof at the central portion of the active region AR. In the present embodiment, the thickness of the dummy color filter layer 20B in the inactive region FR is thinner than the thickness of the color filter layer 13B (19B) in the active region AR. In addition, in the present embodiment, the thickness of the dummy color filter layer 20B is thinner than that in Embodiment 1 (FIG. 4). For this reason, in the present embodiment, the level difference D2 between the surface of the edge color filter layer 19R and the surface of the dummy color filter layer 20B is further suppressed than in Embodiment 1 (FIG. 4).

As a result, in FIG. 15, the thickness of the overcoat layer 14 in the region near the end portion of the active region AR is equal to that at the central portion of the active region AR and is more uniform as compared with that in Embodiment 1 (FIG. 4).

As a result of the above, the thickness of the second λ/4 layer 7 at the end portion of the active region AR is equal to that at the central portion of the active region AR. In other words, according to the present embodiment, the difference between the thickness of the second λ/4 layer 7 at the end portion of the active region AR and the thickness thereof at the central portion of the active region AR is sufficiently suppressed. Hence, the difference between the in-plane retardation of the second λ/4 layer 7 at the end portion of the active region AR and the in-plane retardation thereof at the central portion of the active region AR is sufficiently suppressed, and thus light leakage at the end portion of the active region AR in the black display state is further suppressed than in Embodiment 1 (FIG. 4).

### Examples and Comparative Examples

Hereinafter, the present invention will be described in more detail with reference to Examples and Comparative Examples, but the present invention is not limited to these examples.

In Examples and Comparative Examples, the in-plane retardations of the first λ/4 layer and the second λ/4 layer indicate values with respect to light having a wavelength of 550 nm. Incidentally, light having a wavelength of 550 nm is light having a wavelength at which the human visual sensitivity is the highest. Moreover, the orientation of the transmission axis of the first polarizing plate, the orientation of the in-plane slow axis of the first λ/4 layer, the orientation of the in-plane slow axis of the second λ/4 layer, the alignment direction of the liquid crystal molecules, and the orientation of the transmission axis of the second polarizing plate are defined as an angle when the longitudinal direction of the liquid crystal display panel (the horizontal direction in the drawing) is taken as the reference (0°) and the counterclockwise direction is taken as positive (+).

### Example 1

As the liquid crystal display panel of Example 1, the liquid crystal display panel of Embodiment 1 was manufactured. The constituent members of the liquid crystal display panel of Example 1 were as follows.

### <First Polarizing Plate>

As the first polarizing plate 4, a polarizer (absorption type polarizing plate) obtained by dyeing and adsorbing an iodine complex (or dye) on a polyvinyl alcohol film and then performing stretching and alignment was used. The orientation of the transmission axis of the first polarizing plate 4 was 0°.

### <First λ/4 Layer>

As the first λ/4 layer 5, one fabricated by the following method was used. First, a photoisomerization type photoalignment material was applied onto the surface of a polyethylene terephthalate film by a slit coating method to form a film of photoalignment material.

Thereafter, this film of photoalignment material was pre-baked at 80° C. for 1 minute. As a result, a horizontal alignment film (photoalignment film) was obtained. Next, the photopolymerizable liquid crystal material (liquid crystal material having an acrylate group at the terminal of the skeleton of the liquid crystal molecule, anisotropy of refractive index Δn: 0.14) was dissolved in propylene glycol monomethyl ether acetate (organic solvent). Thereafter, the obtained solution was applied onto the surface of the horizontal alignment film by the slit coat method to form a film of solution. Thereafter, this film of solution was pre-baked at 90° C. for 80 seconds and irradiated with ultraviolet light (wavelength: 313 nm, irradiation amount: 500 mJ). As a result, a laminate of the first λ/4 layer 5 and the polyethylene terephthalate film was obtained. Thereafter, the obtained laminate was pasted to the surface of the first substrate 6 (first support base 11) on the opposite side (observation surface side) to the liquid crystal layer 8 from the opposite side (first λ/4 layer 5 side) to the polyethylene terephthalate film with an adhesive interposed therebetween and then the polyethylene terephthalate film was peeled off. The specifications of the first λ/4 layer 5 were as follows.

Thickness: 1.0 μm

In-plane retardation: 140 nm

Orientation of in-plane slow axis: −45°

### <First Substrate>

A color filter substrate was used as the first substrate 6 and the constituent members thereof were as follows.

(First support base 11)

Glass substrate

Thickness: 0.7 mm

(Black Matrix 12)

Material: Black resist (light shielding percentage: 99.9%)

Thickness: 1.0 μm

Width: 680 μm (in inactive region FR)

(Color filter layer 13R (edge color filter layer 19R))

Material: Pigment-dispersed color resist

Thickness: 2.4 μm

Vertical width: 75 μm

Horizontal width: 25 μm

(Color filter layer 13G)

Material: Pigment-dispersed color resist

Thickness: 2.5 μm

Vertical width: 75 μm

Horizontal width: 25 μm

(Color filter layer 13B (edge color filter layer 19B))

Material: Pigment-dispersed color resist

Thickness: 2.6 μm

Vertical width: 75 μm

Horizontal width: 25 μm

(Dummy color filter layer 20B)

Material: Pigment-dispersed color resist

Thickness: 2.6 μm

Width D1: 100 μm

(Overcoat layer 14)

Material: Transparent resin

Thickness: 1.3 μm (at central portion of active region AR)

### <Second λ/4 Layer>

As the second λ/4 layer 7, one fabricated by the following method was used. First, a polyimide-based alignment material was applied onto the surface of the first substrate 6 on the liquid crystal layer 8 side (rear surface side) to form a film of alignment material. Thereafter, this film of alignment material was pre-baked at 90° C. for 2 minutes and then post-baked at 220° C. for 2 minutes. As a result, a horizontal alignment film was obtained. The surface of the horizontal alignment film was rubbed in a direction of 45° with respect to the longitudinal direction of the liquid crystal display panel 2 (first substrate 6). Next, the photopolymerizable liquid crystal material (liquid crystal material having an acrylate group at the terminal of the skeleton of the liquid crystal molecule, anisotropy of refractive index Δn: 0.14) was dissolved in propylene glycol monomethyl ether acetate (organic solvent). Thereafter, the obtained solution was applied onto the surface of the horizontal alignment film on the liquid crystal layer 8 side (rear surface side) by the slit coating method to form a film of solution. Thereafter, this film of solution was pre-baked at 90° C. for 80 seconds, irradiated with ultraviolet light (wavelength: 313 nm, irradiation amount: 500 mJ), and then post-baked at 230° C. for 30 minutes. As a result, the second λ/4 layer 7 was obtained. The specifications of the second λ/4 layer 7 were as follows.

Thickness: 1.0 μm (at central portion of active region AR)

In-plane retardation: 140 nm (at central portion of active region AR)

Orientation of in-plane slow axis: 45°

A photo spacer (height: 3.0 μm) was disposed on the surface of the second λ/4 layer 7 on the liquid crystal layer 8 side (rear surface side).

### <Liquid Crystal Layer>

As the material for the liquid crystal layer 8, a negative liquid crystal material (anisotropy of dielectric constant Δε: −3.6) was used. The alignment direction of the liquid crystal molecules in the liquid crystal layer 8 (when a voltage was not applied) was 90°.

### <Second Substrate>

A thin-film transistor array substrate in an FFS mode was used as the second substrate 9, and the constituent members were as follows.

(Second support base 18)

Glass substrate

Thickness: 0.7 mm

(Common electrode 17)

Material: Indium zinc oxide

(Insulating film 16)

Material: Silicon nitride

Thickness: 300 nm

(Pixel electrode 15)

Material: Indium zinc oxide

A horizontal alignment film was disposed on the surface of the second substrate 9 on the liquid crystal layer 8 side (observation surface side) using the same material and method as those used when a horizontal alignment film was disposed on the surface of the first substrate 6 on the liquid crystal layer 8 side (rear surface side).

### <Second Polarizing Plate>

As the second polarizing plate 10, a polarizer (absorption type polarizing plate) obtained by dyeing and adsorbing an iodine complex (or dye) on a polyvinyl alcohol film and then performing stretching and alignment was used. The orientation of the transmission axis of the second polarizing plate 10 was 90°.

The relation between the first substrate 6 and the second λ/4 layer 7 was as follows.

In FIG. 3, the surface of the dummy color filter layer 20B was located at a position higher than the surface of the edge color filter layer 19B by 1.0 μm. In other words, the level difference D2 between the surface of the edge color filter layer 19B and the surface of the dummy color filter layer 20B was 1.0 μm. By this, the thickness of the overcoat layer 14 in the region of the width D3: 25 μm (about 1 pixel width) from the end portion of the active region AR was thicker than that at the central portion of the active region AR by D4: 0.04 μm at the maximum. As a result, the thickness of the second λ/4 layer 7 at the end portion of the active region AR was 0.96 μm to be thinner than the thickness (1.0 μm) thereof at the central portion of the active region AR by the thickness change D4: 0.04 μm of the overcoat layer 14. Hence, the in-plane retardation of the second λ/4 layer 7 at the end portion of the active region AR was 134.4 nm (=0.14×960 nm (0.96 μm)) and the difference thereof from the in-plane retardation (140 nm) of the second λ/4 layer 7 at the central portion of the active region AR was 5.6 nm.

In FIG. 4, the surface of the dummy color filter layer 20B was located at a position higher than the surface of the edge color filter layer 19R by 1.2 μm. In other words, the level difference D2 between the surface of the edge color filter layer 19R and the surface of the dummy color filter layer 20B was 1.2 μm. By this, the thickness of the overcoat layer 14 in the region of the width D3: 25 μm (about 1 pixel width) from the end portion of the active region AR was thicker than that at the central portion of the active region AR by D4: 0.06 μm at the maximum. As a result, the thickness of the second λ/4 layer 7 at the end portion of the active region AR was 0.94 μm to be thinner than the thickness (1.0 μm) thereof at the central portion of the active region AR by the thickness change D4: 0.06 μm of the overcoat layer 14. Hence, the in-plane retardation of the second λ/4 layer 7 at the end portion of the active region AR was 131.6 nm (=0.14×940 nm (0.94 μm)) and the difference thereof from the in-plane retardation (140 nm) of the second λ/4 layer 7 at the central portion of the active region AR was 8.4 nm.

### Example 2

As the liquid crystal display panel of Example 2, the liquid crystal display panel of Embodiment 2 was manufactured. The liquid crystal display panel of Example 2 was manufactured in the same manner as the liquid crystal display panel of Example 1 except that the dummy color filter layer 20B was changed to the following dummy color filter layer 20R.

(Dummy Color Filter Layer 20R)

Material: Pigment-dispersed color resist

Thickness: 2.4 μm

Width D1: 100 μm

The relation between the first substrate 6 and the second λ/4 layer 7 was as follows.

In FIG. 6, the surface of the dummy color filter layer 20R was located at a position higher than the surface of the edge color filter layer 19B by 0.8 μm. In other words, the level difference D2 between the surface of the edge color filter layer 19B and the surface of the dummy color filter layer 20R was 0.8 μm. By this, the thickness of the overcoat layer 14 in the region near the end portion of the active region AR was equal to that at the central portion of the active region AR. As a result, the thickness of the second λ/4 layer 7 at the end portion of the active region AR was 1.0 μm to be equal to the thickness (1.0 μm) thereof at the central portion of the active region AR. Hence, the in-plane retardation of the second λ/4 layer 7 at the end portion of the active region AR was 140 nm (=0.14×1000 nm (1.0 μm)) and was equal to the in-plane retardation (140 nm) of the second λ/4 layer 7 at the central portion of the active region AR.

In FIG. 7, the surface of the dummy color filter layer 20R was located at a position higher than the surface of the edge color filter layer 19R by 1.0 μm. In other words, the level difference D2 between the surface of the edge color filter layer 19R and the surface of the dummy color filter layer 20R was 1.0 μm. By this, the thickness of the overcoat layer 14 in the region of the width D3: 25 μm (about 1 pixel width) from the end portion of the active region AR was thicker than that at the central portion of the active region AR by D4: 0.04 μm at the maximum. As a result, the thickness of the second λ/4 layer 7 at the end portion of the active region AR was 0.96 μm to be thinner than the thickness (1.0 μm) thereof at the central portion of the active region AR by the thickness change D4: 0.04 μm of the overcoat layer 14. Hence, the in-plane retardation of the second λ/4 layer 7 at the end portion of the active region AR was 134.4 nm (=0.14×960 nm) and the difference thereof from the in-plane retardation (140 nm) of the second λ/4 layer 7 at the central portion of the active region AR was 5.6 nm.

### Example 3

As the liquid crystal display panel of Example 3, the liquid crystal display panel of Embodiment 3 was manufactured. The liquid crystal display panel of Example 3 was manufactured in the same manner as the liquid crystal display panel of Example 1 except that the edge color filter layer 19B was disposed at the entire peripheral portion (entire periphery) of the active region and the width D1 of the dummy color filter layer 20B was changed to 75 μm.

The relation between the first substrate 6 and the second λ/4 layer 7 was as follows.

In FIG. 9, the surface of the dummy color filter layer 20B was located at a position higher than the surface of the edge color filter layer 19B by 1.0 μm. In other words, the level difference D2 between the surface of the edge color filter layer 19B and the surface of the dummy color filter layer 20B was 1.0 μm. By this, the thickness of the overcoat layer 14 in the region of the width D3: 50 μm (about 2 pixel width) from the end portion of the active region AR was thicker than that at the central portion of the active region AR by D4: 0.06 μm at the maximum. As a result, the thickness of the second λ/4 layer 7 at the end portion of the active region AR was 0.94 μm to be thinner than the thickness (1.0 μm) thereof at the central portion of the active region AR by the thickness change D4: 0.06 μm of the overcoat layer 14. Hence, the in-plane retardation of the second λ/4 layer 7 at the end portion of the active region AR was 131.6 nm (=0.14×940 nm (0.94 μm)) and the difference thereof from the in-plane retardation (140 nm) of the second λ/4 layer 7 at the central portion of the active region AR was 8.4 nm. The above results were the same at both the left end and right end portions of the active region AR.

### Example 4

As the liquid crystal display panel of Example 4, the liquid crystal display panel of Embodiment 4 was manufactured. The liquid crystal display panel of Example 4 was manufactured in the same manner as the liquid crystal display panel of Example 1 except that the overcoat layer 14 was not disposed.

The relation between the first substrate 6 and the second λ/4 layer 7 was as follows.

In FIG. 11, the surface of the dummy color filter layer 20B was located at a position higher than the surface of the edge color filter layer 19B by 1.0 μm. In other words, the level difference D2 between the surface of the edge color filter layer 19B and the surface of the dummy color filter layer 20B was 1.0 μm. By this, the thickness of the second λ/4 layer 7 in the region of the width D5: 25 μm (about 1 pixel width) from the end portion of the active region AR was thicker than that at the central portion of the active region AR by D6: 0.04 μm at the maximum. As a result, the thickness of the second λ/4 layer 7 at the end portion of the active region AR was 1.04 μm to be thicker than the thickness (1.0 μm) thereof at the central portion of the active region AR by 0.04 μm. Hence, the in-plane retardation of the second λ/4 layer 7 at the end portion of the active region AR was 145.6 nm (=0.14×1040 nm (1.04 μm)) and the difference thereof from the in-plane retardation (140 nm) of the second λ/4 layer 7 at the central portion of the active region AR was 5.6 nm.

In FIG. 12, the surface of the dummy color filter layer 20B was located at a position higher than the surface of the edge color filter layer 19R by 1.2 μm. In other words, the level difference D2 between the surface of the edge color filter layer 19R and the surface of the dummy color filter layer 20B was 1.2 μm. By this, the thickness of the second λ/4 layer 7 in the region of the width D5: 25 μm (about 1 pixel width) from the end portion of the active region AR was thicker than that at the central portion of the active region AR by D6: 0.06 μm at the maximum. As a result, the thickness of the second λ/4 layer 7 at the end portion of the active region AR was 1.06 μm to be thicker than the thickness (1.0 μm) thereof at the central portion of the active region AR by 0.06 μm. Hence, the in-plane retardation of the second λ/4 layer 7 at the end portion of the active region AR was 148.4 nm (=0.14×1060 nm (1.06 μm)) and the difference thereof from the in-plane retardation (140 nm) of the second λ/4 layer 7 at the central portion of the active region AR was 8.4 nm.

### Example 5

As the liquid crystal display panel of Example 5, the liquid crystal display panel of Embodiment 5 was manufactured. The liquid crystal display panel of Example 5 was manufactured in the same manner as the liquid crystal display panel of Example 1 except that the thickness of dummy color filter layer 20B was changed to 1.6 μm.

The relation between the first substrate 6 and the second λ/4 layer 7 was as follows.

In FIG. 14, there was no level difference between the surface of the edge color filter layer 19B and the surface of the dummy color filter layer 20B. By this, the thickness of the overcoat layer 14 in the region near the end portion of the active region AR was equal to that at the central portion of the active region AR. As a result, the thickness of the second λ/4 layer 7 at the end portion of the active region AR was 1.0 μm to be equal to the thickness (1.0 μm) thereof at the central portion of the active region AR. Hence, the in-plane retardation of the second λ/4 layer 7 at the end portion of the active region AR was 140 nm (=0.14×1000 nm (1.0 μm)) and was equal to the in-plane retardation (140 nm) of the second λ/4 layer 7 at the central portion of the active region AR.

In FIG. 15, the surface of the dummy color filter layer 20B was located at a position higher than the surface of the edge color filter layer 19R by 0.2 μm. In other words, the level difference D2 between the surface of the edge color filter layer 19R and the surface of the dummy color filter layer 20B was 0.2 μm. By this, the thickness of the overcoat layer 14 in the region near the end portion of the active region AR was equal to that at the central portion of the active region AR. As a result, the thickness of the second λ/4 layer 7 at the end portion of the active region AR was 1.0 μm to be equal to the thickness (1.0 μm) thereof at the central portion of the active region AR. Hence, the in-plane retardation of the second λ/4 layer 7 at the end portion of the active region AR was 140 nm (=0.14×1000 nm (1.0 μm)) and was equal to the in-plane retardation (140 nm) of the second λ/4 layer 7 at the central portion of the active region AR.

### Comparative Example 1

The liquid crystal display panel of Comparative Example 1 was manufactured in the same manner as the liquid crystal display panel of Example 1 except that the dummy color filter layer 20B was not disposed.

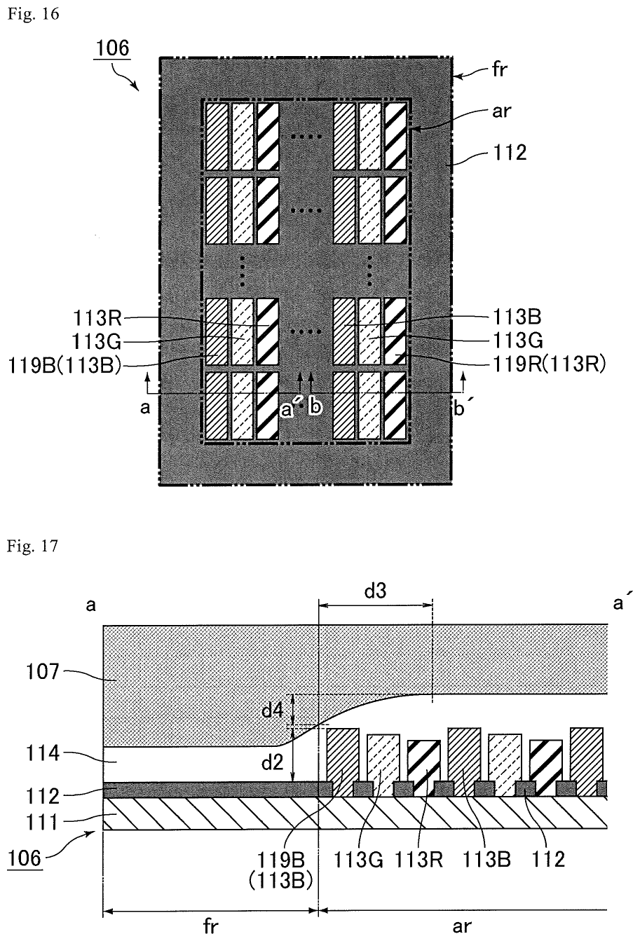

FIG. 16 is a schematic plan view illustrating a state in which a first substrate and a second λ/4 layer of the liquid crystal display panel of Comparative Example 1 are viewed from the liquid crystal layer side (rear surface side). As illustrated in FIG. 16, a first substrate 106 includes color filter layers 113R, 113G, and 113B in the active region ar in which an image is displayed. Among these color filter layers, an edge color filter layer 119B (blue: color filter layer 113B) is located at the left end portion of the active region ar and an edge color filter layer 119R (red: color filter layer 113R) is located at the right end portion of the active region ar. Meanwhile, the first substrate 106 includes a black matrix 112 but does not include a dummy color filter layer in the inactive region (frame region) fr surrounding the active region ar.

The relation between the first substrate 106 and a second λ/4 layer 107 was as follows.

FIG. 17 is a schematic cross-sectional view illustrating a portion corresponding to a line segment a-a′ in FIG. 16. In FIG. 17, the surface of the black matrix 112 in the inactive region fr was located at a position lower than the surface of the edge color filter layer 119B by 1.6 μm. In other words, the level difference d2 between the surface of the edge color filter layer 119B and the surface of the black matrix 112 was 1.6 μm. By this, the thickness of an overcoat layer 114 in the region of the width d3: 100 μm (about 4 pixel width) from the end portion of the active region ar was thinner than that at the central portion of the active region ar by d4: 0.1 μm at the maximum. As a result, the thickness of the second λ/4 layer 107 at the end portion of the active region ar was 1.1 μm to be thicker than the thickness (1.0 μm) thereof at the central portion of the active region ar by the thickness change d4: 0.1 μm of the overcoat layer 114. Hence, the in-plane retardation of the second λ/4 layer 107 at the end portion of the active region ar was 154 nm (−0.14×1100 nm (1.1 μm)) and the difference thereof from the in-plane retardation (140 nm) of the second λ/4 layer 107 at the central portion of the active region ar was 14 nm.

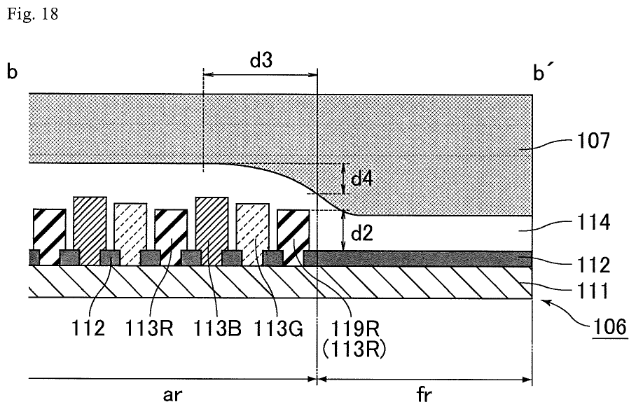

FIG. 18 is a schematic cross-sectional view illustrating a portion corresponding to a line segment b-b′ in FIG. 16. In FIG. 18, the surface of the black matrix 112 in the inactive region fr was located at a position lower than the surface of the edge color filter layer 119R by 1.4 μm. In other words, the level difference d2 between the surface of the edge color filter layer 119R and the surface of the black matrix 112 was 1.4 μm. By this, the thickness of an overcoat layer 114 in the region of the width d3: 100 μm (about 4 pixel width) from the end portion of the active region ar was thinner than that at the central portion of the active region ar by d4: 0.08 μm at the maximum. As a result, the thickness of the second λ/4 layer 107 at the end portion of the active region ar was 1.08 μm to be thicker than the thickness (1.0 μm) thereof at the central portion of the active region ar by the thickness change d4: 0.08 μm of the overcoat layer 114. Hence, the in-plane retardation of the second λ/4 layer 107 at the end portion of the active region ar was 151.2 nm (−0.14×1080 nm (1.08 μm)) and the difference thereof from the in-plane retardation (140 nm) of the second λ/4 layer 107 at the central portion of the active region ar was 11.2 nm.

### [Evaluation]

The end portions (particularly, the left end portion and right end portion) of the active region when the liquid crystal display panel of each example was in the black display state were visually observed in a dark room (environment with an illuminance of 0.1 lx or less). As a result, light leakage was not visually recognized in the liquid crystal display panels of Examples 1 to 5. On the other hand, light leakage was visually recognized in the liquid crystal display panel of Comparative Example 1.

The liquid crystal display panel of Example 1 and the liquid crystal display panel of Comparative Example 1 are considered to have a difference in the appearance of light leakage at the end portions of the active region for the following reason.

### (Left End Portion)

The difference between the in-plane retardation of the second λ/4 layer at the end portion of the active region and the in-plane retardation thereof at the central portion of the active region in Example 1 (5.6 nm) was smaller than that in Comparative Example 1 (14 nm).

The width of the region in which the thickness of the second λ/4 layer changed in Example 1 (25 μm) was smaller than that in Comparative Example 1 (100 μm).

### (Right End Portion)

The difference between the in-plane retardation of the second λ/4 layer at the end portion of the active region and the in-plane retardation thereof at the central portion of the active region in Example 1 (8.4 nm) was smaller than that in Comparative Example 1 (11.2 nm).

The width of the region in which the thickness of the second λ/4 layer changed in Example 1 (25 μm) was smaller than that in Comparative Example 1 (100 μm).

The liquid crystal display panel of Example 2 and the liquid crystal display panel of Comparative Example 1 are considered to have a difference in the appearance of light leakage at the end portions of the active region for the following reason.

### (Left End Portion)

The difference between the in-plane retardation of the second λ/4 layer at the end portion of the active region and the in-plane retardation thereof at the central portion of the active region in Example 2 (0 nm) was smaller than that in Comparative Example 1 (14 nm). Incidentally, light leakage was not visually recognized even when the liquid crystal display panel was observed under a polarizing microscope in Example 2 (the left end portion of the active region) and the display quality was particularly excellent.

### (Right End Portion)

The difference between the in-plane retardation of the second λ/4 layer at the end portion of the active region and the in-plane retardation thereof at the central portion of the active region in Example 2 (5.6 nm) was smaller than that in Comparative Example 1 (11.2 nm).

The width of the region in which the thickness of the second λ/4 layer changed in Example 2 (25 μm) was smaller than that in Comparative Example 1 (100 μm).

The liquid crystal display panel of Example 3 and the liquid crystal display panel of Comparative Example 1 are considered to have a difference in the appearance of light leakage at the end portions of the active region for the following reason.

### (Left End Portion)

The difference between the in-plane retardation of the second λ/4 layer at the end portion of the active region and the in-plane retardation thereof at the central portion of the active region in Example 3 (8.4 nm) was smaller than that in Comparative Example 1 (14 nm).

The width of the region in which the thickness of the second λ/4 layer changed in Example 3 (50 μm) was smaller than that in Comparative Example 1 (100 μm).

### (Right End Portion)

The difference between the in-plane retardation of the second λ/4 layer at the end portion of the active region and the in-plane retardation thereof at the central portion of the active region in Example 3 (8.4 nm) was smaller than that in Comparative Example 1 (11.2 nm). Furthermore, the color of the edge color filter layer in Example 3 (blue) had a lower visual sensitivity than that in Comparative Example 1 (red).

The width of the region in which the thickness of the second λ/4 layer changed in Example 3 (50 μm) was smaller than that in Comparative Example 1 (100 μm).

The liquid crystal display panel of Example 4 and the liquid crystal display panel of Comparative Example 1 are considered to have a difference in the appearance of light leakage at the end portions of the active region for the following reason.

### (Left End Portion)

The difference between the in-plane retardation of the second λ/4 layer at the end portion of the active region and the in-plane retardation thereof at the central portion of the active region in Example 4 (5.6 nm) was smaller than that in Comparative Example 1 (14 nm).

The width of the region in which the thickness of the second λ/4 layer changed in Example 4 (25 μm) was smaller than that in Comparative Example 1 (100 μm).

### (Right End Portion)

The difference between the in-plane retardation of the second λ/4 layer at the end portion of the active region and the in-plane retardation thereof at the central portion of the active region in Example 4 (8.4 nm) was smaller than that in Comparative Example 1 (11.2 nm).

The width of the region in which the thickness of the second λ/4 layer changed in Example 4 (25 μm) was smaller than that in Comparative Example 1 (100 μm).

The liquid crystal display panel of Example 5 and the liquid crystal display panel of Comparative Example 1 are considered to have a difference in the appearance of light leakage at the end portions of the active region for the following reason.

### (Left End Portion)

The difference between the in-plane retardation of the second λ/4 layer at the end portion of the active region and the in-plane retardation thereof at the central portion of the active region in Example 5 (0 nm) was smaller than that in Comparative Example 1 (14 nm). Incidentally, light leakage was not visually recognized even when the liquid crystal display panel was observed under a polarizing microscope in Example 5 (the left end portion of the active region) and the display quality was particularly excellent.

### (Right End Portion)

The difference between the in-plane retardation of the second λ/4 layer at the end portion of the active region and the in-plane retardation thereof at the central portion of the active region in Example 5 (0 nm) was smaller than that in Comparative Example 1 (11.2 nm). Incidentally, light leakage was not visually recognized even when the liquid crystal display panel was observed under a polarizing microscope in Example 5 (the right end portion of the active region) and the display quality was particularly excellent.

### ADDITIONAL REMARKS

An aspect of the present invention may be a liquid crystal display panel including: in order from an observation surface side to a rear surface side, a first polarizing plate; a first λ/4 layer; a first substrate; a second λ/4 layer; a liquid crystal layer; a second substrate; and a second polarizing plate, the first λ/4 layer having an in-plane slow axis which forms an angle of 45° with a transmission axis of the first polarizing plate and is orthogonal to an in-plane slow axis of the second λ/4 layer, the second substrate including a pair of electrodes which generate a horizontal electric field in the liquid crystal layer when a voltage is applied, the liquid crystal layer including liquid crystal molecules which are homogeneously aligned in a state in which a voltage is not applied between the pair of electrodes, the first substrate including a plurality of color filter layers in an active region in which an image is displayed, the plurality of color filter layers including an edge color filter layer located at an end portion of the active region, the first substrate including a black matrix and a dummy color filter layer which overlaps the black matrix and is adjacent to the edge color filter layer in order from the observation surface side to the rear surface side in an inactive region surrounding the active region, a level difference between a surface of the edge color filter layer and a surface of the dummy color filter layer being 1.2 μm or less, and the second λ/4 layer overlapping a boundary between the edge color filter layer and the dummy color filter layer. According to this aspect, a liquid crystal display panel in a horizontal electric field mode is realized which exhibits excellent visibility in a bright place and causes suppressed light leakage at the end portion of the active region.

The level difference may be 0.8 μm or less. According to such a configuration, the thickness uniformity of the second λ/4 layer in the active region is increased and thus light leakage at the end portion of the active region is effectively suppressed.

A width of the dummy color filter layer may be 75 μm or more. According to such a configuration, the thickness uniformity of the second λ/4 layer in the active region is increased and thus light leakage at the end portion of the active region is effectively suppressed.

A color of the dummy color filter layer may be the same as a color of a color filter layer having a thinnest thickness among the plurality of color filter layers. According to such a configuration, the thickness uniformity of the second λ/4 layer in the active region is increased and thus light leakage at the end portion of the active region is effectively suppressed.

A color of the edge color filter layer may be blue. According to such a configuration, a blue edge color filter layer having a low visual sensitivity is disposed as the edge color filter layer and thus light leakage at the end portion of the active region is hardly visually recognized.

The first substrate may further include an overcoat layer which directly covers the plurality of color filter layers and the dummy color filter layer. According to such a configuration, the overcoat layer can be utilized as a flattening layer for the plurality of color filter layers and the dummy color filter layer.

The second λ/4 layer may directly cover the plurality of color filter layers and the dummy color filter layer. According to such a configuration, the second λ/4 layer can be utilized as a flattening layer for the plurality of color filter layers and the dummy color filter layer.

A transmission axis of the first polarizing plate and a transmission axis of the second polarizing plate may be orthogonal to each other. According to such a configuration, the first polarizing plate and the second polarizing plate are disposed in crossed Nicols and thus a black display state can be effectively realized when a voltage is not applied.

An alignment direction of the liquid crystal molecules in the liquid crystal layer and a transmission axis of either one of the first polarizing plate or the second polarizing plate may be parallel to each other in a state in which a voltage is not applied between the pair of electrodes. According to such a configuration, a black display state can be effectively realized when a voltage is not applied.

Another aspect of the present invention may be a liquid crystal display device including the liquid crystal display panel. According to this aspect, a liquid crystal display device in a horizontal electric field mode is realized which exhibits excellent visibility in a bright place and causes suppressed light leakage at the end portion of the active region.

### REFERENCE SIGNS LIST

1 liquid crystal display device
2 liquid crystal display panel
3 backlight
4 first polarizing plate
5 first λ/4 layer (out-cell retardation layer)
6, 106 first substrate
7, 107 second λ/4 layer (in-cell retardation layer)
8 liquid crystal layer
9 second substrate
10 second polarizing plate
11, 111 first support base
12, 112 black matrix
13R, 13G, 13B, 113R, 113G, 113B color filter layer
14, 114 overcoat layer
15 pixel electrode
16 insulating film
17 common electrode
18 second support base
19R, 19B, 119R, 119B edge color filter layer
20R, 20B dummy color filter layer
AR, ar active region
FR, fr inactive region (frame region)
D1 width of dummy color filter layer
D2 level difference between surface of edge color filter layer and surface of dummy color filter layer
d2 level difference between surface of edge color filter layer and surface of black matrix
D3, d3 width of region in which thickness of overcoat layer changes
D4, d4 thickness change of overcoat layer
D5 width of region in which thickness of second λ/4 layer changes
D6 thickness change of second λ/4 layer

1. A liquid crystal display panel comprising: in order from an observation surface side to a rear surface side,
a first polarizing plate;
a first λ/4 layer;
a first substrate;
a second λ/4 layer;
a liquid crystal layer;
a second substrate; and
a second polarizing plate,
the first λ/4 layer having an in-plane slow axis which forms an angle of 45° with a transmission axis of the first polarizing plate and is orthogonal to an in-plane slow axis of the second λ/4 layer,
the second substrate including a pair of electrodes which generate a horizontal electric field in the liquid crystal layer when a voltage is applied,
the liquid crystal layer including liquid crystal molecules which are homogeneously aligned in a state in which a voltage is not applied between the pair of electrodes,
the first substrate including a plurality of color filter layers in an active region in which an image is displayed,
the plurality of color filter layers including an edge color filter layer located at an end portion of the active region,
the first substrate including a black matrix and a dummy color filter layer which overlaps the black matrix and is adjacent to the edge color filter layer in order from the observation surface side to the rear surface side in an inactive region surrounding the active region,
a level difference between a surface of the edge color filter layer and a surface of the dummy color filter layer being 1.2 μm or less, and
the second λ/4 layer overlapping a boundary between the edge color filter layer and the dummy color filter layer.

2. The liquid crystal display panel according to claim 1,
wherein the level difference is 0.8 μm or less.

3. The liquid crystal display panel according to claim 1,
wherein a width of the dummy color filter layer is 75 μm or more.

4. The liquid crystal display panel according to claim 1,
wherein a color of the dummy color filter layer is the same as a color of a color filter layer having a thinnest thickness among the plurality of color filter layers.

5. The liquid crystal display panel according to claim 1,
wherein a color of the edge color filter layer is blue.

6. The liquid crystal display panel according to claim 1,
wherein the first substrate further includes an overcoat layer which directly covers the plurality of color filter layers and the dummy color filter layer.

7. The liquid crystal display panel according to claim 1,
wherein the second λ/4 layer directly covers the plurality of color filter layers and the dummy color filter layer.

8. The liquid crystal display panel according to claim 1,
wherein a transmission axis of the first polarizing plate and a transmission axis of the second polarizing plate are orthogonal to each other.

9. The liquid crystal display panel according to claim 1,
wherein an alignment direction of the liquid crystal molecules in the liquid crystal layer and a transmission axis of either one of the first polarizing plate or the second polarizing plate are parallel to each other in a state in which a voltage is not applied between the pair of electrodes.

10. A liquid crystal display device comprising the liquid crystal display panel according to claim 1.
